(19) United States
(12) Patent Application Publication
(10) Pub. No.: US 2007/0122441 A1
(43) Pub. Date: May 31, 2007

(54) Biocidal surfaces, articles with biocidal surface agents and methods of synthesizing and evaluating biocidal surface agents

(76) Inventors: Hironobu Murata, Pittsburgh, PA (US); Richard R. Koespel, Pittsburgh, PA (US); Sang B. Lee, Harrison City, PA (US); Alan J. Russell, Gibsonia, PA (US)

Correspondence Address: BARTONY & HARE, LLP, 1806 FRICK BUILDING, 437 GRANT STREET, PITTSBURGH, PA, 15219-6101, US

(21) Appl. No.: 11/601,949

(22) Filed: Nov. 20, 2006

Related U.S. Application Data
(60) Provisional application No. 60/738,258, filed on Nov. 18, 2005.

(51) Int. Cl. A01N 57/00; A01N 25/00

(52) U.S. Cl. 424/405; 514/114

(57) ABSTRACT

A biocidal article, includes a surface including a plurality of polymers covalently attached to the surface. The polymers include biocidal cationic groups. The polymers have a molecular weight distribution or polydispersity less than 3. A grafting density of the polymers on the surface is controlled, average degree of polymerization of the polymers is controlled and repeat units of the polymers are chosen to provide a predetermined charge density arising from the cationic groups. A method of analyzing biocidal activity of biocidal surface agents includes the steps: attaching a plurality of chemical entities to one or more surfaces so that at least one physiochemical property is varied, each of the chemical entities comprising at least one biocidally active component; and exposing the chemical entities to at least one biological agent to determine the effect of the at least one physiochemical property upon biocidal activity. The biocidal activity can, for example, be antibacterial activity or sporicidal activity. The at least one physiochemical property can, for example, be varied in a preferably systematic manner.

### CROSS-REFERENCE TO RELATED APPLICATION

This application claims benefit of U.S. Provisional Patent Application No. 60/738,258, filed Nov. 18, 2005, the disclosure of which is incorporated herein by reference.

### BACKGROUND OF THE INVENTION

The present invention relates to biocidal or antimicrobial surfaces, articles with biocidal or antimicrobial surface agents and to methods of synthesizing and evaluating biocidal or antimicrobial surface agents, and, particularly, to methods of synthesizing and evaluating biocidal or antimicrobial surface agents via combinatorial, controlled radical polymerization processes.

References set forth herein may facilitate understanding of the present invention or the background of the present invention. Inclusion of a reference herein, however, is not intended to and does not constitute an admission that the reference is available as prior art with respect to the present invention. The disclosure of all references set forth herein are incorporated herein by reference.

The mechanism by which an antimicrobial acts determines how it can be used in surface treatments. Most conventional antimicrobials act by diffusing into the cell and disrupting essential cell functions. To use this type of compound for surface treatment, the antimicrobial must be released from the surface matrix. These leachable biocides types are typically compositions containing antibiotics, phenols, iodine, quaternary ammonium compounds, or heavy metals such as silver, tin and mercury. See, for example, Golubovich. V. N. & Rabotnova, I. L. (1974) Microbiol 43, 948-950; Nohr, R. S. & Macdonald, G. J. (1994) J. Biomater, Sci. Polym. Ed. 5, 607-619; Shearer, A. E., Paik, J. S., Hoover, D. G., Haynie, S. L. & Kelley, M. J. (2000) Biotechnol. Bioeng. 67, 141-146. The freedom of the antimicrobial to leave the surface in the case of leachable biocides has adverse effects on the durability and useful life of the treated material. Moreover, compounds released into the environment at sub lethal concentrations can have the effect of increasing drug resistance throughout the microbial realm.

A type of renewable releasing surface coating for fabrics and other surfaces has been described which releases halide ions and can be renewed though a bleach treatment. Klueh, U., Wagner, V., Kelly, S., Johnson, A., & Bryers, J. D. (2000) J. Biomed. mater. Res., Appl. Biomater. 53, 621-631. These materials are effective at killing bacteria but require regeneration to maintain activity.

A more unconventional route to the production of surface-active antimicrobial materials is binding of an antimicrobial to the surface, usually via covalent attachment. See, for example, Sun, G., Xu, X., Bickett, J. R. & Williams, J. F. (2001) Ind. Eng. Chem. Res. 40, 1016-1021; Chen, C. Z., Tan, N. C. B. & Cooper, S. L. (1999) Chem. Commun. 1585-1586; Abel, T., Cohen, J. I., Engel, R., Filshtinskaya, M., Melkonian, A. & Melkonian, K. (2002) Carbohydrate Res. 337, 2495-2499; Chen, Y., Worley, S. D., Kim, J., Wei, C.-I., Chen, T.-Y., Santiago, J. I., Williams, J. F. & Sun, G. (2003) Ind. Eng. Chem. Res. 42, 280-284; Tiller, J. C., Liao, C.-J., Lewis, K. & Klibanov, A. M. (2001) Proc. Nat'l Acad. Sci. USA, 98, 5981-5985; Tiller, J. C., Lee, S. B., Lewis, K. & Klibanov, A. M. (2002) Biotechnol. Bioeng. 79, 465-471.

Tiller, et al., have described methods for treating flat surfaces such as glass, high-density polyethylene (HDPE), low-density polyethylene (LDPE), polyprolylene (PP), and Nylon, poly(ethylene terephthalate) with poly(4-vinyl-pyridine) modified with pendant quaternary ammonium salts. The antibacterial properties of those materials were assessed by spraying aqueous suspensions of bacterial cells on the surfaces and counting the survivors. While antimicrobial activity was found, the ability of those surfaces to kill applied organisms was not equal to the leaching types of antimicrobial surface preparations. Interestingly, when the applied polymer was a poly-quaternary amine it was able to kill bacteria that were resistant to other types of cationic antimicrobials. The active material for those studies was synthesized by either classical free radical polymerization or simple coupling reactions and then applied to an activated surface. Those types of reactions fail to strictly control the monomer distribution, polydispersity, molecular weight, polymer topology, and density of functional groups in a way that allows rational modification of the polymer for increased anti-microbial activity.

The control of polymer compositions, architectures, and functionalities for the development of materials with biological properties has long been of interest in polymer chemistry. Controlled/living radical polymerization process (CRPs) such as atom transfer radical polymerization (ATRP) provide a relatively new and versatile method for the synthesis of polymers with controlled molecular weights and low polydispersities. See, for example, Lin, J., Tiller, J. C., Lee, S. B., Lewis, K. & Klibanov, A. M. (2002) Biotechnol. Lett. 24, 801-805; Wang, J.-S. & Matyjaszewski, K. (1995) J. Am. Chem. Soc. 117, 5614-5615; Matyjaszewski, K. & Xia, J. (2001) Chem. Rev. 101, 2921-2990. In general, CRP processes provide compositionally homogeneous well-defined polymers (with predictable molecular weights, narrow molecular weight distribution, and high degree of end-functionalization) and have been the subject of a number of recent review articles. See, for example, Chen, R., Worley, S. D., Kim, Wei, C. I., Chen, T. Y., Santiago, J. I., Williams, J. F. and Sun, G., (2003) Ind. Eng. Chem Res., 42, 280-284 and Tiller, J. C., Liao, C. J., Lewis, K. and Kilbanov, A. M. (2001), Proc. Nat'l Acad. Sci USA, 98, 5981-5985.

Polymeric materials made from vinyl monomers containing primary, secondary or tertiary amino groups including monomers such as 2-(dimethylaminoethyl methacrylate) (DMAEMA), 4-vinyl pyridine (4-VP), N-substituted acrylamides, N-acryloyl pyrrolidine, N-acryloyl piperidine, and acryl-L-amino acid amides are useful for various applications such as water-soluble polymers and coordination reagents for transition metals. See, for example, Qiu, J. & Matyjaszewski, K. (1997) Macromolecules 30, 5643-5648; Patten, T. E. & Matyjaszewski, K. (1998) Adv. Mater. 10, 901-915; Kowalewski, T., Tsarevsky, N. V. & Matyjaszewski, K. (2002) J. Am. Chem. Soc. 124, 10632-10633; Teodorescu, M. & Matyjaszewski, K. (2000) Macromol. Rapid Comm. 21, 190-194; Teodorescu, M. & Matyjaszewski, K. (1999) Macromolecules 32, 4826-4831. Most of these vinyl monomers can be used as substrates for ATRP reactions to make either homopolymers or a variety mixed co-polymers.

Recently, ATRP has been used to produce surfaces with position dependent and gradually varying chemistry. Such “gradient surfaces” can result in position-bound variation in physical properties such as wettability. See, for example, Wu, T., Tomlinson, M., Efimenko, K. and Genzer, J. (2003) J. Mat. Sci, 38, 4471-4477 and Wu, T., Efimenko, K., Vicek, P. and Genzer, J, Macromolecules (2003), 36, 2448-2453.

The use of ATRP to make bioactive polymers has also been studied. See Kamigaito, M., Ando, T. & Sawamoto, M. (2001) Chem. Rev. 101, 3689-3745. It has also been shown that combining the controlled size of long polymer chains produced by ATRP with an effective quaternary ammonium group results in a biocidal polymer. Lee, S. B., Koepsel, R. R., Morley, S. W., Matyjaszewski, K., Sun, Y. and Russell, A. (2004), Biomacromolecules, 5, 877-882.

Although there have been decades of research on the development of biocidal surfaces agents, such efforts have met with only limited success. It is, therefore, very desirable to develop improved biocidal surface agents as well as to develop improved methods of synthesizing and evaluating biocidal surface agents.

### SUMMARY OF THE INVENTION

In one aspect, the present invention provides a biocidal article, including: a surface including a plurality of polymers covalently attached to the surface. The polymers include biocidal cationic groups. The polymers have a molecular weight distribution or polydispersity less than 3. A grafting density of the polymers on the surface is controlled, average degree of polymerization of the polymers is controlled and repeat units of the polymers are chosen to provide a predetermined charge density arising from the cationic groups. The molecular weight distribution can be less than 2.5, less than 2 or even less than 1.5. The predetermined charge density can, for example, be determined specifically for the surface (or type of surface) to which the polymers are attached. Likewise, the predetermined charge density can be determined for at least one specific biological agent (for example, bacteria), for a plurality of specific biological agent or for biological agents generally.

In several embodiments, the polymers can be grown via controlled radical polymerization. For example, the polymers can be grown via atom transfer radical polymerization.

The polymers can, for example, be grown in solution and subsequently attached to the surface. Alternatively, a plurality of initiators can be attached to the surface and the polymers can be grown from the initiators.

In several embodiments, the biocidally active groups include at least one of a quaternary ammonium salt and a quaternary phosphonium salt.

Grafting density can, for example, be controlled by reaction of blocking (non-initiating) compounds with active groups on the surface.

The plurality of polymers can be one of homopolymers and copolymers. The plurality of polymers can, for example, include at least one of a block copolymer, a multiblock copolymer, a random copolymer, a graft polymer, a branched polymer, a star polymer, a hyperbranched polymer, or a gradient copolymer.

The plurality of polymers can, for example, have an average degree of polymerization between 4 and 10000, of between 4 and 1000, or of between 4 and 100.

At least one monomer for growing the polymers can, for example, be derived from at least one of 2-(dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers.

The surface can, for example be at least one of silicon, gold, silica functionality, a cellulosic materials, a surface with one of amino and hydroxy functionality, plain glass, amino glass, polymeric material, a polymeric coating, polyethylene, polypropylene, polystyrene, aluminum, steel, paper, wood, porcelain, wool, cotton, porous glass beads and ion exchanger resin.

The biocidal article can include a linking group between the surface and the polymer. The linking group can, for example, have the formula:

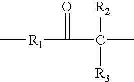

where R₁ is one of O, an ester, amide, aliphatic hydrocarbon, aromatic hydrocarbon or NH, R₂ and R₃ are, independently, one of H, CH₃, OOCC₂H₅ or CN. A monomeric or repeat unit of at least a portion of the plurality of polymers can include the biocidally active group. The monomeric unit can, for example, be at least one monomeric unit selected from the following formulae: 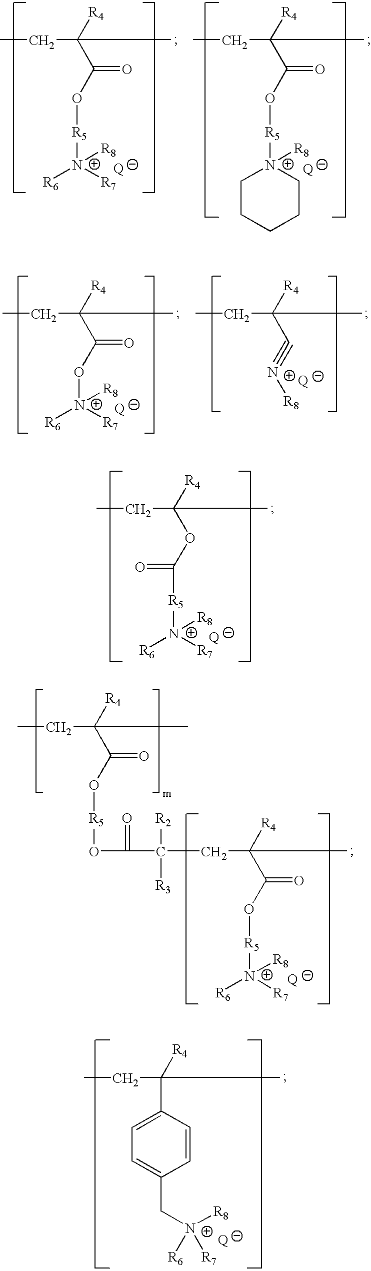 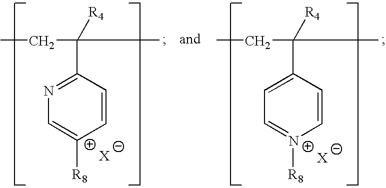
where R₄ is one of H, CH₃, Cl or CN, R₅ is —(CH₂)ₙ— and —CH₂C(CH₃)₂CH₂—, n is from 1 to 6, R₆ and R7 are, independently, one of alkyl C₁-C₅ or isopropyl, R₈ is H, alkyl C₁-C₁₆ and benzyl and Q is one of F, Cl, Br, I, CF₃SO₃ and CF₃CO₂, individually or in any combination each, X is a radically transferable atom or group or a group derived from the radically transferable atom or group, such as an additional polymer block, a hydroxy group, H, branched or straight chain alkyl or cyclic, and Q is one of F, Cl, Br, I, CF₃SO₃ and CF₃CO₂.

In another aspect, the present invention provides a process for preparing a biocidal article, including: controlling a grafting density of polymers that are covalently attached to a surface, the polymers including biocidal cationic groups, controlling a chain length of the polymers, and choosing repeat units of the polymers; such that a predetermined charge density arising from the cationic groups is achieved.

At least one of grafting density, chain length, repeat units and charge density can, for example, be determined by attaching a plurality the polymers to one or more of the surfaces so that at least one of grafting density, chain length or repeat units is varied; and exposing the polymer to at least one agent. For example, a gradient can be created in at least a first direction on the surface before exposing the polymer to at least one agent.

The polymers can, for example, be grown via controlled radical polymerization. For example, the polymers can be grown via atom transfer radical polymerization.

The polymers can be grown in solution and subsequently attached to the surface. Alternatively, a plurality of initiators can be attached to the surface, and the polymers can be grown from the initiators.

The biocidal cationic groups can include at least one of a quaternary ammonium salt and a quaternary phosphonium salt.

Polymerization can occurs in the presence of a system initially including a transition metal complex and initiator attached to the surface which includes a radically transferable atom or group. The radically transferable atom or group can, for example, be one of a chlorine, iodine, and bromine.

The monomers can, for example, include at least one 2-(dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, or derivatives or substituted varieties of such monomers.

The cationic groups can, for example, be added to the polymers by converting a group thereof to a quaternary salt by reacting the group with an alkyl halide. The alkyl halide can be one of C₁-C₁₂ alkyl halide. The halide of the alkyl halide can be one of chlorine and bromine.

The process can further include the act of reacting a compound comprising an initiator group with a functional group on the surface to form an initiator attached to the surface. The functional group on the surface can, for example, be at least one of —OH and —NH₂. A blocking agent without initiation functionality can also be reacted with functional groups on the surface of the article to control grafting density.

In another aspect, the present invention provides a method of analyzing biocidal activity of biocidal surface agents, including the steps: attaching a plurality of chemical entities to one or more surfaces so that at least one physiochemical property is varied, each of the chemical entities comprising at least one biocidally active component; and exposing the chemical entities to at least one biological agent to determine the effect of the at least one physiochemical property upon biocidal activity. The biocidal activity can, for example, be antibacterial activity or sporicidal activity.

The at least one physiochemical property can, for example, be varied in a systematic manner. The at least one physiochemical property can, for example, be a physiochemical property of the surface to which the chemical entities are attached or a physiochemical property of the chemical entities.

The chemical entities can be chemically bonded to the one or more surfaces. In a number of embodiments of the present invention the chemical entities are polymers. The polymers can be polymerized in a controlled radical polymerization process such as atom transfer radical polymerization. The polymers can, for example, be grown/polymerized on the surface or can be polymerized and subsequently attached to the surface via at least one surface reactive group of the polymers. In a controlled radical polymerization on surfaces such as atom transfer radical polymerization, polymers are bonded to the one or more surfaces by polymerizing radically polymerizable monomers from an initiator attached to the one or more surfaces.

In one embodiment of the present invention, polymers are attached to a single surface and the at least one physiochemical property is a varied to create a gradient in the at least one physiochemical property in a first direction on the surface. At least a second physiochemical property can be varied to create a gradient in the second physiochemical property in a second direction on the surface. The first direction and the second direction can be generally orthogonal.

Many physiochemical properties can be varied, including but not limited to, at least one of molecular weight, average chain length, degree of polymerization, polydispersity, degree of surface reactivity, local homogeneity (that is, a small region of identical molecules) of the biocidally active component, macro homogeneity (that is, the overall chemical identity) of the biocidally active component; surface density or grating density of the polymeric chemical entities, architecture of the polymeric chemical entities, number of points of attachment to the surface of the polymeric chemical entities, chemical composition of the polymeric chemical entities or surface topology. In several embodiments, average chain length (or degree of polymerization), grafting density and/or monomer chemical identity are varied to achieve a desired or effective charge density. As used herein, the term “degree of polymerization” or DP refers generally the number of repeat units in an average polymer chain. Degree of polymerization can be converted into average chain length (for example, in nanometers) as the length of the monomers/repeat units is known.

The polymeric chemical entities of the present invention can be homopolymers or copolymers. Copolymeric chemical entities can, for example, be block copolymers, random copolymers or graft copolymers. The polymeric chemical entities can, for example, be dendritic polymers, comb polymers, linear polymers, branched polymers, or star polymers.

The surfaces of the present invention can include at least one of silicon, gold, a cellulosic material, glass, a polymeric material, aluminum, steel, porcelain, wool, cotton or an ion exchanger resin. Glass surfaces can include a plain glass, an amino glass or a porous glass bead. Cellulosic materials include, but are not limited to, paper or wood. In several embodiments, the surfaces include at least one of silica functionality, amino functionality or hydroxy functionality. The surfaces can also include a polymeric coating (for example, polyethylene, polypropylene or polystyrene).

In several preferred embodiments of the present invention, a combinatorial library of surfaces are formed. A plurality of surfaces can be formed wherein a first physiochemical property is maintained generally constant on all the surfaces and a second physiochemical property is varied in a systematic manner among the surfaces. A plurality of physiochemical properties can be varied in a systematic manner in the combinatorial library of surfaces.

The method can further include the step of analyzing the effect of the at least one physiochemical property upon the biological agent. For example, a marking agent adapted to provide an indication of the viability of the biological agent can be added. In one embodiment, the biological agent is a bacteria (or other living agent) and the marking agent provides an indication of whether the bacteria is dead or alive.

In another aspect, the present invention provides a method of analyzing biological activity of biologically active surface agents, including the steps: attaching a plurality of chemical entities to one or more surfaces so that at least one physiochemical property is varied, each of the chemical entities comprising at least one biologically active component; and exposing the chemical entities to at least one agent to determine the effect of the physiochemical property on biological activity.

In another aspect, the present invention provides a method of preparing a surface for testing of biological (for example, biocidal) activity, including the step: attaching a plurality of chemical entities to the surface so that at least one physiochemical property of the chemical entities is varied to create a gradient in the at lease one physiochemical property in a first direction on the surface, each of the chemical entities comprising at least one biologically active segment.

In a further aspect, the present invention provides a method of preparing a surface for testing of biological (for example, biocidal) activity, including the step: attaching a plurality of chemical entities to the surface so that at least one physiochemical property of the chemical entities is varied over an area of the surface in a known manner, each of the chemical entities comprising at least one biologically active segment. In one embodiment, at least a second physiochemical property is varied over the area of the surface in a known manner.

### BRIEF DESCRIPTION OF THE DRAWINGS

FIG. 1 illustrates a synthetic pathway for the ATRP polymerization and subsequent quaternization of DMAEMA on solid surfaces.

FIG. 2 illustrates another example of a synthetic route to produce quaternary ammonium polymer brushes.

FIG. 3 illustrates the preparation of various surfaces with varying grafting density or surface coverage and varying polymer chain length.

FIG. 4 illustrates the results of adsorption studies (501 nm) of fluorescein as a function of initiator concentration on the surfaces produced as described in FIG. 2 for samples having two different polymer molecular weights (Mn of Poly(DMAEMA)) and polydispersities.

FIG. 5 illustrates the preparation of a surface with a gradient in initiator concentration/grafting density over the length of the surface.

FIG. 6 illustrates ATRP polymerization of DMAEMA on the gradient-initiated surface and subsequent quaternization.

FIG. 7 illustrates an image of fluorescein tags on a surface produced in a manner similar to that set forth in FIGS. 5 and 6.

FIG. 8 illustrates the preparation of a combinatorial surface with a gradient in polymer chain length over the length of the surface.

FIG. 9 illustrates an image of fluorescein tags on a surface produced in a manner similar to that set forth in FIG. 8.

FIG. 10 illustrates the results of an adsorption study (501 nm) of fluorescein as a function of position/chain length on the surface.

FIG. 11 illustrates a multi-dimensional (for example, a two-dimensional) combinatorial surface in which more than one physiochemical property is varied spatially over the area of the surface.

FIG. 12 illustrates an overview of a combinatorial approach for exploring spatial areas of high biocidal activity in surfaces with multi-dimensional gradients in physiochemical properties as described above.

FIG. 13 illustrates an example of the preparation of a slide having a gradient in grafting density over the length thereof.

FIG. 14A illustrates the results of fluorescein testing of a slide prepared by the process of FIG. 13.

FIG. 14B illustrates the result of water droplet contact angle testing of a slide prepared by the process of FIG. 13.

FIG. 15 illustrates an example of a slide broken or otherwise divided or separated into sections for testing of the sections.

FIG. 16 illustrates a method of using an iCyte™ Automated Imaging Cytometer to study the effect of a surface such as a slide prepared, for example, by the process of FIG. 13 on bacteria.

FIG. 17 illustrates a cytometer scan of a slide having a two-dimensional, orthogonal gradient in grafting density and average chain length (or degree of polymerization (DP), which is the number of repeat units in an average polymer chain).

FIG. 18 illustrates a three-dimensional representation of scan data for the two-dimensional slide of FIG. 17 showing color density verses position on the slide, wherein the color density is a relative measure of the activity of the surface.

FIG. 19 illustrates dry layer thickness (nm) data results of silicon wafers formed in the same manner as the slide of FIG. 17 and overlayed onto the scanned slide of FIG. 17.

FIG. 20 illustrates charge density calculated from chain length results of silicon wafers formed in the same manner as the slide of FIG. 17 and overlayed onto the scanned slide of FIG. 17.

FIG. 21 illustrates several different polymer architectures/topologies that can be produced in the present invention via, for example, ATRP.

FIG. 22A illustrates that each molecule can be coupled to a surface via a single or multiple sites.

FIG. 22B illustrates that an antimicrobial solution in which surface reactive polymers have been grown can be sprayed or otherwise applied onto surface like conventional antibacterial materials (see FIG. 14b).

### DETAILED DESCRIPTION OF THE INVENTION

Previous approaches to develop biocidal surface agents (BSA's) have met with only limited success because agents that have been incorporated were not designed to be active when delivered from a surface. In general, no biocidal agents have been designed specifically to function in association with a surface. Prior to the present invention, known biocidal molecules were simply added to surfaces and materials. In general, the level of activity and the resilience of the bioactive component of such systems are insufficient for many uses.

As used herein, the terms “biocidal,” “biocidally active” or “antimicrobial” refer generally to an ability of a composition or group to inhibit the growth of, inhibit the reproduction of or kill microorganisms: such as, without limitation, spores and bacteria, fungi, mildew, mold, and algae.

In the present invention, biocidal surface agents with improved performance (for example, activity and resiliency) are developed by generating a relatively large number of biocidal surface agents in a combinatorial manner to produce screenable combinatorial libraries or systems. High-throughput screening can be used to identify desirable biocidal surface agents and build a library of biocidal polymers on surfaces. The “ground up” development of biocidal surface agents of the present invention provides a substantial improvement over prior approaches discussed above. Biocidal surface agents can be developed to exhibit substantial biocidal activity even at relatively low surface loading.

The term “combinatorial” is generally defined as 1) of, relating to, or involving combinations; or 2) of, or relating to the arrangement of, operation on, and selection of discrete elements belonging to finite sets. A combinatorial process can, for example, be used to prepare sets of compounds from sets of building blocks (for example, sets of different reactants). In general, compound synthesis can be designed such that a range of structures are produced simultaneously as mixtures in the same reaction vessel or individually in parallel using semi-automated synthesis. Tens, hundreds, or thousands of different compounds of known structures can be prepared in the time that it would take to prepare only a few pure entities by orthodox methodology.

As used in connection with the present invention, the term “combinatorial” refers to the production of a number (and preferably a relatively large number) of biocidal surface agents in which at least one physiochemical property is altered among the biocidal surface agents. Preferably, the physiochemical property is altered in a known or systematic manner. The physiochemical properties that can be altered are not limited to the chemical building blocks (or monomers) used to produce polymeric biocidal agents on the surfaces of the present invention. Physiochemical properties of the surface (for example, chemical composition, microstructure etc.) as well as a wide variety of physiochemical properties of the polymeric biocidal agents can be altered. Representative physiochemical properties that can be altered include, but are not limited to, polymer chain length, polymer/copolymer chemical composition, copolymer sequence, surface material, surface topology or microstructure, polymer molecular weight; polydispersity; degree of surface reactivity; local homogeneity of a bio-active component, macro homogeneity of a bio-active component; and surface coverage or grafting density.

Controlled variation of polymer physiochemical properties (polymer compositions, architectures, functionalities etc.) for the development of surface materials of the present invention with biocidal properties can, for example, be achieved using controlled/living radical polymerization processes. Atom transfer radical polymerization or ATRP, nitroxide mediated polymerization (NMP), reversible addition fragmentation chain transfer (RAFT) and catalytic chain transfer (CCT) are examples of controlled/living radical polymerization processes or CRP that provide versatile methods for controlled synthesis of polymers.

As use herein, the term “controlled” refers to the ability to produce a product having one or more properties which are reasonably close to their predicted value (presuming a particular initiator efficiency). For example, if one assumes 100% initiator efficiency, the molar ratio of monomer to initiator leads to a particular predicted molecular weight.

Similarly, one can “control” the polydispersity or molecular weight distribution by ensuring that the rate of deactivation is the same or greater than the initial rate of propagation. However, the importance of the relative deactivation/propagation rates decreases proportionally with increasing polymer chain length and/or increasing predicted molecular weight or degree of polymerization. Controlled radical polymerizations can produce polymers that, when grown from surfaces, have narrow molecular weight distributions, or polydispersities, such as less than or equal to 3, or in certain embodiments less than or equal to 2.0 or less than or equal to 1.5. In certain embodiments, molecular weight distributions of less than 1.2 can be achieved. Control of polymer properties in CRP, and in ATRP specifically, is discussed, for example, in Zhang, et al., Controlled/“Living” Radical Polymerization of 2-(Dimethylamino)ethyl Methacrylate, Macromolecules, 31, 5167-5169 (1998).

ATRP is one of the most robust CRP and a large number of monomers can be polymerized providing compositionally homogeneous well-defined polymers having predictable molecular weights, narrow molecular weight distribution, and high degree of end-functionalization. For this reason, ATRP is used in a number of representative studies of the present invention. Matyjaszewski and coworkers have produced a number of patents, patent applications and journal articles related to ATRP. See, for example, U.S. Pat. Nos. 5,763,546; 5,807,937; 5,789,487; 5,945,491; 6,111,022; 6,121,371; 6,124,411; 6,162,882; 6,407,187; 6,512,060; U.S. patent application Ser. Nos. 09/018,554; 09/359,359; 09/359,591; 09/369,157; 09/534,827; 09/972,046; 09/972,056; 09/972,260; 10/034,908; and 10/098,052; Matyjaszewski, K., Ed. Controlled Radical Polymerization; ACS: Washington, D.C., 1998; ACS Symposium Series 685; Matyjaszewski, K., Ed. Controlled/Living Radical Polymerization. Progress in ATRP, NMP, and RAFT; ACS: Washington, D.C., 2000; ACS Symposium Series 768; Matyjaszewski, K., Davis, T. P., Eds. Handbook of Radical Polymerization; Wiley: Hoboken, 2002; Qiu, J.; Charleux, B.; Matyjaszewski, K. Prog. Polym. Sci. 2001, 26, 2083; and Davis, K. A.; Matyjaszewski, K. Adv. Polym. Sci. 2002, 159, 1, the disclosures of which are incorporated herein by reference. A used herein, “ATRP” or “atom transfer radical polymerization” refer generally to a controlled/living radical polymerization as, for example, described by Matyjaszewski in the Journal of Americal Chemical Society, vol. 117, page 5614 (1995), as well as in ACS Symposium Serves 768, and Handbook of Radical Polymerization, Wiley: Hobolcer 2002, Matyiaszewski, K and Davis, T, editors, the disclosure of which are incorporated by reference.

ATRP enables one to, for example, build block copolymers of tight dispersity with relative ease. In the present invention, ATRP can be used to grow numerous (for example, tens of thousands or millions) of screenable BSAs from a number of surfaces (including, for example, ceramic, metal, polymeric and glass surfaces) in parallel or generally simultaneously to identify BSAs that are surface active in formulations that mimic real world surfaces. Use of non-combinatorial ATRP in the synthesis of a number of biocidal surface agents is described in Published PCT International Patent Application Serial No. WO/2005/084159, entitled Antimicrobial Surfaces and Methods for Preparing Antimicrobial Surfaces, and in Lee, S. B., Koepsel, R. R., Morley, S. W., Matyjaszewski, K., Sun, Y. and Russell, A. (2004), Biomacromolecules, 5, 877-882, the disclosures of which are incorporated herein by reference.

ATRP uses a monomer, an initiator with a transferable halogen, and a catalyst composed of a transition metal with a suitable ligand. An “ATRP initiator” is a chemical molecule, with a transferable (pseudo)halogen that can initiate chain growth. Fast initiation is important to obtain well-defined polymers with low polydispersities. A variety of initiators, typically alkyl halides, have been used successfully in ATRP. Many different types of halogenated compounds are potential initiators. Reversible atom transfer can occur between the transition metal complex and the growing radicals thereby reducing the free radical concentration and decreasing the probability of termination by radical coupling. ATRP can be used in many solvents to grow polymers from surfaces. Although, ATRP may not be a practical method to coat materials on a large scale, it is quite useful on smaller scales and has been used on a variety of surfaces including, for example, gold, silica surfaces and porous substrates. One can, for example, use combinatorial ATRP to identify novel polymers for BSAs, and, subsequently, use conventional polymerizations to synthesize the materials in bulk form such that they can react with pre-existing surfaces.

Many monomers have been successfully polymerized by CRP, including ATRP. See Handbook at Radical Polymerization, Matyjaszewski, K and Davis, T. P., John Wiley and Sons, Inc., Hoboken, N.J. (2002), the disclosure of which is incorporated herein by reference. In general, vinyl monomers are used in ATRP. The polymers attached to the surface may be homopolymers, copolymers, block polymer, graft polymers, dendritic polymers, random copolymers, comb polymers, branched polymers, star polymers, hyperbranched polymers, polymeric brushes, as well as any other polymeric structure that allow access of the biocidally active groups to the organism. The biocidally active group can be incorporated into the entire backbone, a single block, multiple blocks, or branches of the homopolymers or copolymer or in more than one part of the polymer.

A number of biocidally active agents can be incorporated into the biocidal surface agents of the present invention. Classes of known biocidal agents include, for example, quaternary cation-containing polymers (for example, polyquaternary ammonium ion-containing or phosphonium ion-containing polymers), chloramines and porphyrin derivatives. Polyquaternary ammonium or phosphonium ion-containing polymers derivatives are known to effectively kill cells and spores by disrupting membranes. Polyquaternary ammonium or phosphonium ion-containing polymers have never been combined in single polymer chains and topologies with other biocidal species. Although polyquaternary ammonium and phosphonium ion-containing polymers are known to be surface active, there is relatively little known about physiochemical properties (for example, chain length, grafting density etc.) required to achieve optimal activity.

Chloramines are renewable bleaches that can oxidize and kill. Chloramines not only kill, but also release oxidants that disrupt bacteria, spores and, potentially more importantly, the debris that is released from destroyed cells. The chloramines-induced degradation of cell and spore debris can thereby induce self-renewal of surface immobilized materials of the present invention.

In addition to the above surface-active biocides, singlet delta oxygen (SDO) generating organic compounds can be incorporated within the matrix of the biocidal surface agents of the present invention. SDO can oxidize the biologicals (and contaminants) in a similar, but less aggressive manner, as TiO₂. SDO generators are already proven biocides. In the case of, for example, chloramines and porphyrin one can expect to kill spores and/or microbes and then degrade the debris.

In several representative studies of the present invention, combinatorial ATRP (C-ATRP) was used to generate a variety of surface-attached polyquaternary ammonium ion-containing polymers. Sets or libraries of such polymers having different average chain length (or degree of polymerization) and different grafting densities were formed on one or more surfaces.

Modified surfaces of the present invention can, for example, comprise polymers having quaternary amines produced from any unsaturated, radically polymerizable, monomer containing a primary, secondary or tertiary nitrogen (or a functionality that can be converted into quaternary amine after the polymerization reaction). Monomers comprising the biocidally active groups can, for example, be derived from monomers such as 2-(dimethylamino)ethyl methacrylate (DMAEMA), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers. Polymers comprising these monomeric compounds can easily be converted to chemical forms with known anitmicrobial activity including the facile conversion of DMAEMA to a corresponding series of quaternary amines. For example, ATRP can be used as a robust mechanism for growing long chain, low polydispersity polymers on a surface using DMAEMA as a monomer. The tertiary amino group of the DMAEMA, which is pendant to the main chain of the polymer, is easily quarternized by different chain lengths of alkyl halides to provide an effective biocidal functionality. DMAEMA was used to synthesize homopolymers using ATRP in representative several studies of the present invention.

The amino groups on such monomers can be converted to a quaternary salt via reaction with an alkyl halide. In embodiments, the alkyl halide may be any one of C₁-C₂₀ alkyl halide (such as, but not limited to, methyl chloride, methyl iodide, methyl bromide, methyl bromide, ethyl bromide, butyl bromide, pentyl bromide, hexyl bromide, heptyl bromide, octyl bromide, nonyl bromide, decyl bromide, undecyl bromide, dodecyl bromide, tridecyl bromide, tetradecyl bromide, heptadecyl bromide, or hexadecyl bromide). The halide of the alkyl halide can be chlorine, bromine, fluorine, and iodine.

In the present invention, well-defined biocidal surfaces having a high density of quaternary ammonium salts and substantial biocidal activity were prepared. Such biocidal surfaces can be prepared by avoiding chain terminations from chain transfer, radical coupling, or disproportionation during the polymerization reaction. These deleterious side reactions can, for example, be controlled by conducting a CRP reaction with monomers capable of being converted to biocidally active groups as described above, herein exemplified by ATRP.

For example, the following modified monomeric units can add biocidal activity to a polymer:

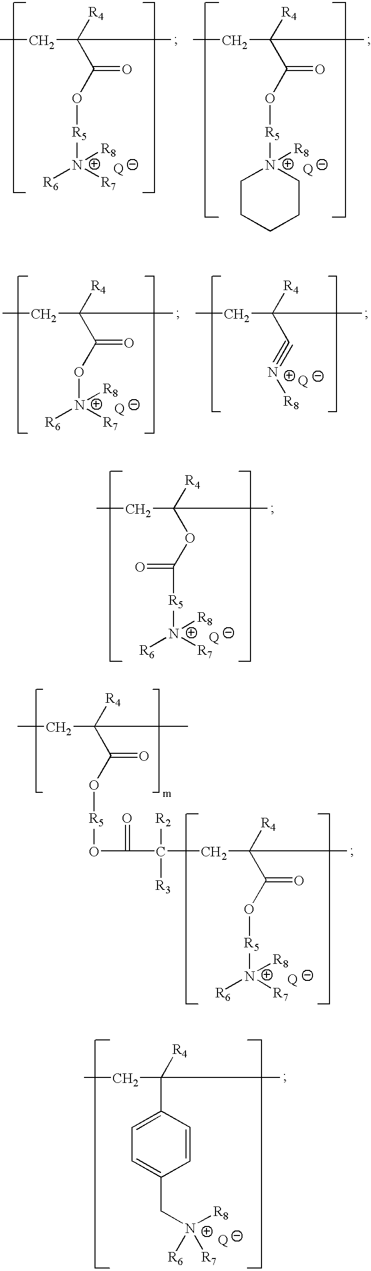

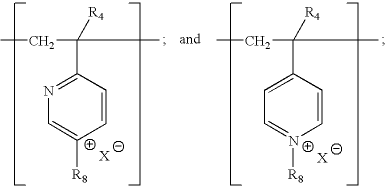

wherein R₄ is one of H, CH₃, Cl or CN, R₅ is —(CH₂)ₙ— and —CH₂C(CH₃)₂CH₂—, n is from 1 to 6, R₆ and R7 are, independently, one of alkyl C₁-C₅ or isopropyl, R₈ is H, alkyl C₁-C₁₆ and benzyl and Q is one of F, Cl, Br, I, CF₃SO₃ and CF₃CO₂, individually or in any combination each, X is a radically transferable atom or group or a group derived from the radically transferable atom or group, such as an additional polymer block, a hydroxy group, H, branched or straight chain alkyl or cyclic, and Q is one of F, Cl, Br, I, CF₃SO₃ and CF₃CO₂.

In CRP embodiments of the present invention, a plurality of polymers can be attached to any surface that has or may be modified to have controlled polymerization initiation sites. For example, materials including reactive groups such as at least one of amino or hydroxy functional groups can be used. Suitable surfaces can, for example, comprise silicon, a metal (such as gold, aluminum or steel), silica functionality, a cellulosic material (for example, paper or wood), glass (for example, plain glass, amino glass, porous glass beads etc.), a polymeric material or a polymeric coating, (for example, polyethylene, polypropylene, polystyrene etc.), wool, cotton, or ion exchanger resin. A linking group between such surfaces and the attached polymer can be formed. In general, any linking group can be used, including, but not limited to, linking groups have the formula: 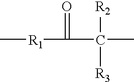
where R₁ is one of O, an ester, amide, aliphatic hydrocarbon, aromatic hydrocarbon or NH, R₂ and R₃ are, independently, one of H, CH₃, OOCC₂H₅ or CN.

### Combinatorial Studies

In one embodiment of the present invention, individual surfaces having different physiochemical properties can be created. For example a 96-well plate or a 1056-well plate can be coated with a surface, (for example, a ceramic, a metal, a glass or an organic surface) using standard fluid handling techniques as known in the art. Likewise, individual glass slides can be used as surfaces upon which such polymers can be grown. After any appropriate chemical activation of the surface (as known in the art), parallel/simultaneous ATRP reactions can be initiated on each individual surface. For example, multiple cycles of polymerization can provide for addition of a different monomeric component in each cycle.

In another embodiment of the present invention, a gradient in one or more physiochemical properties is created over the area of a single surface. In this embodiment, varying biocidal activity (as a function of varying physiochemical property(ies)) is associated with varying position on the surface.

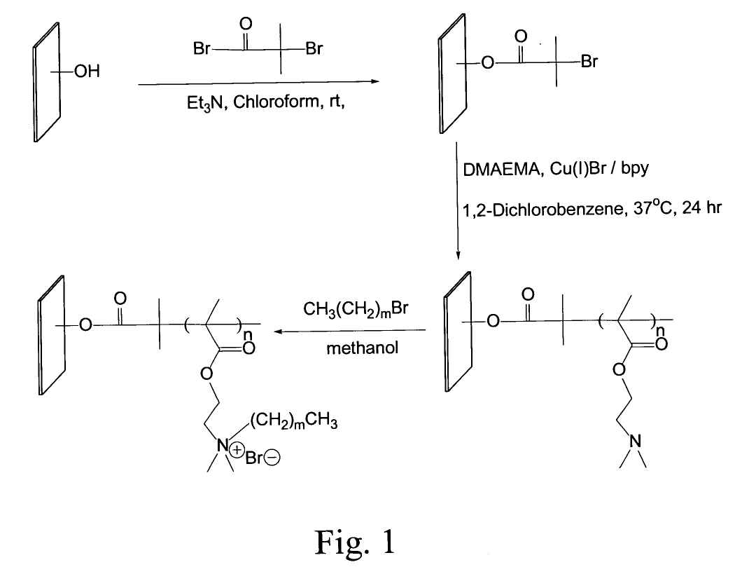

An example of how quaternary ammonium ion-containing acrylates can be synthesized from a surface is illustrated in FIG. 1. FIG. 1 outlines a synthetic pathway for the ATRP polymerization and subsequent quaternization of DMAEMA on solid surfaces. In the reaction scheme of FIG. 1, 2-bromoisobutyryl bromide can be reacted with the hydroxyl or amine groups in a solid substrate to produce the active ATRP initiator on surface. ATRP can then be used to polymerize DMAEMA to the initiated surfaces. Cu(I)Br and the ligand bpy (bipyridine) serve as catalysts in the ATRP reaction, and 1,2-dichlorobenzene could be the solvent. After washing, the materials can be quaternized with an alkyl halide using nitromethane as a solvent. Varying chain length can be created by varying polymerization time and/or monomer concentration.

To alter surface coverage or grafting density of polymer, the surface concentration, coverage or density of active initiator sites can be varied. One can, for example, use “blocking agents” to vary initiator site concentration. For example, propionyl bromide can be mixed stoichiometrically with varying amounts of 2-bromoisobutyryl bromide to vary the density of active ATRP initiation sites on the surface. The propionyl bromide reacts with the hydroxyl groups found on the surface to produce a non-polymerizable site.

In general, a surface has a defined number of active sites with which a chemical entity such a CRP initiator or a blocking agent can bind or react. One can assume (given generally equivalent functionality and kinetics) that, for example, a mixture of 50 mole % initiator and 50 mole % blocking agent will result in a surface in which 50% of the available reactive sites are reacted with initiator.

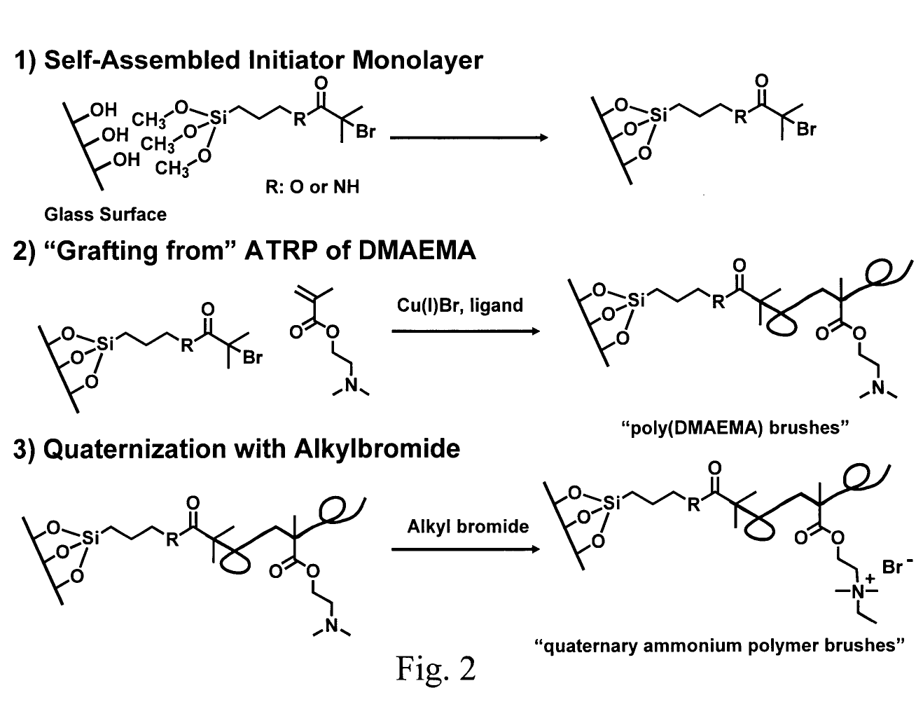

Another example of a synthetic route to produce quaternary ammonium polymer brushes is illustrated in FIG. 2. Further details of the synthesis of polymeric brushes of the present invention are provided in the Experimental section below. In the synthetic route of FIG. 2, a trialkoxysilyl (for example, trimethoxysilyl or TMS) functionality of the ATRP initiator was reacted with hydroxy groups on the surface to create an initiator monolayer. ATRP was then be used to polymerize DMAEMA to the initiated surfaces. As in FIG. 1, Cu(I)Br and a ligand served as catalysts in the ATRP reaction. The resultant polymers were quaternized with an alkylbromide.

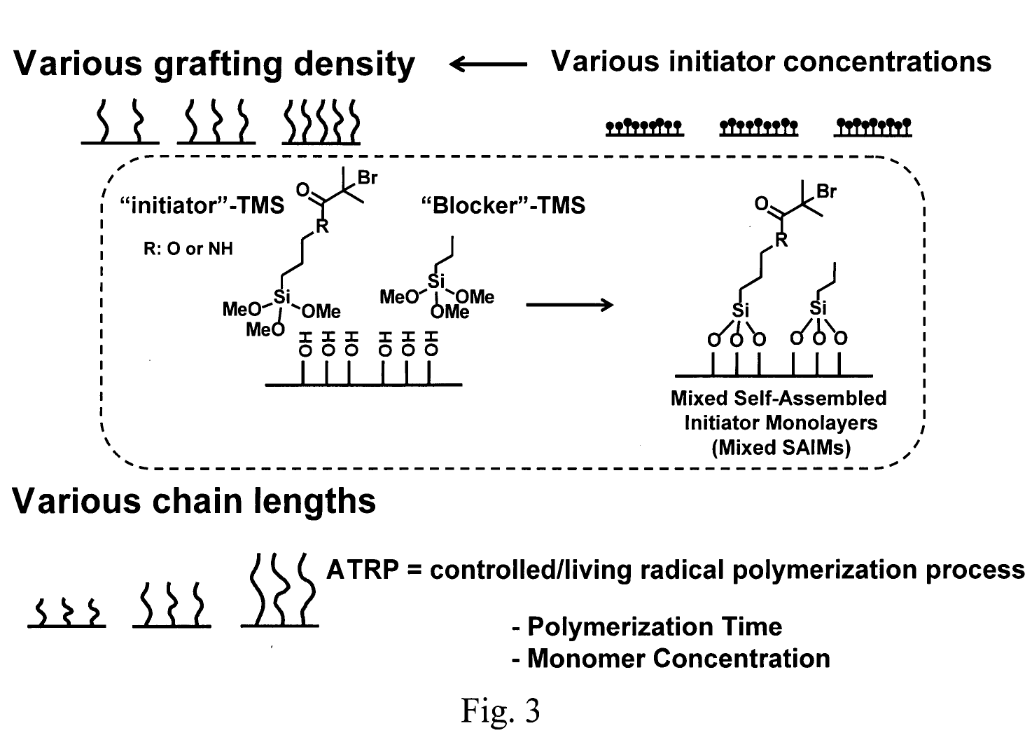

As illustrated in FIG. 3, in several studies grafting density or surface coverage was varied over different individual glass slides by varying active initiator site concentration. In that regard, an alkoxysilyl (for example, trimethoxysilyl or TMS) functionalized blocker was used to create inactive, non-polymerizable sites. As also illustrated in FIG. 3, polymer chain length was varied over individual glass slides by varying polymerization time and/or monomer concentration.

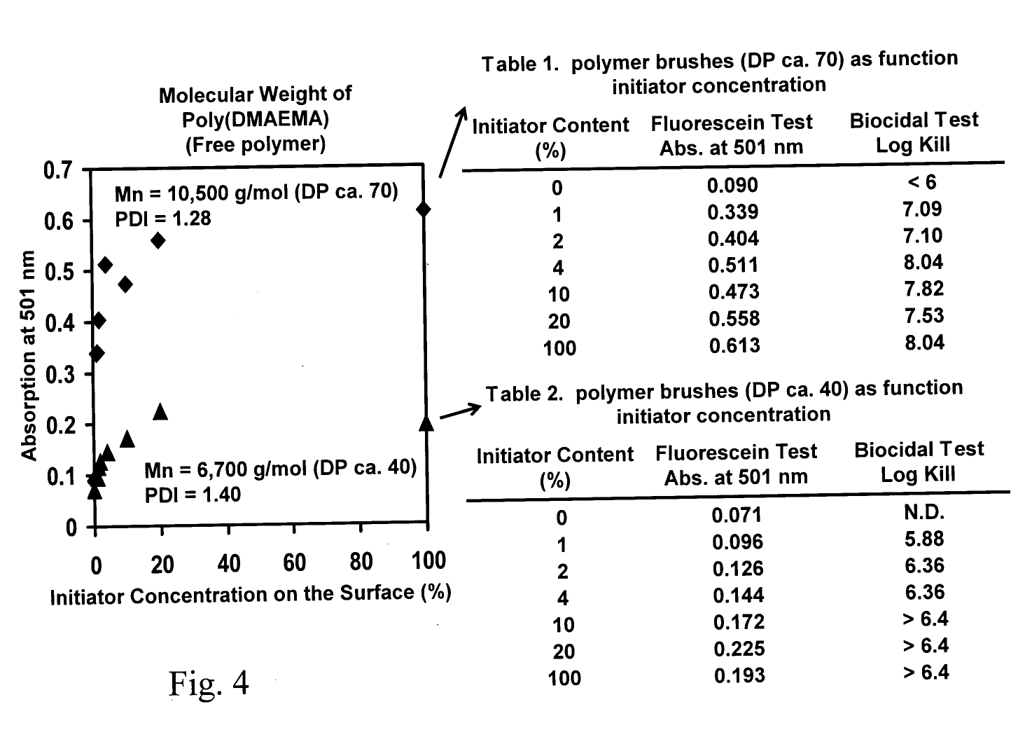

FIG. 4 and accompanying Tables 1 and 2 set forth the results of adsorption studies (501 nm) of fluorescein as a function of initiator concentration on the surfaces produced as described in FIG. 2 for samples having two different polymer molecular weights (Mn of Poly(DMAEMA)) and polydispersities. Tables 1 and 2 also set forth the results of biocidal testing on the surfaces. As seen from Tables 1 and 2, log kill in the biocidal testing leveled off at initiator concentrations between 2 and 4%.

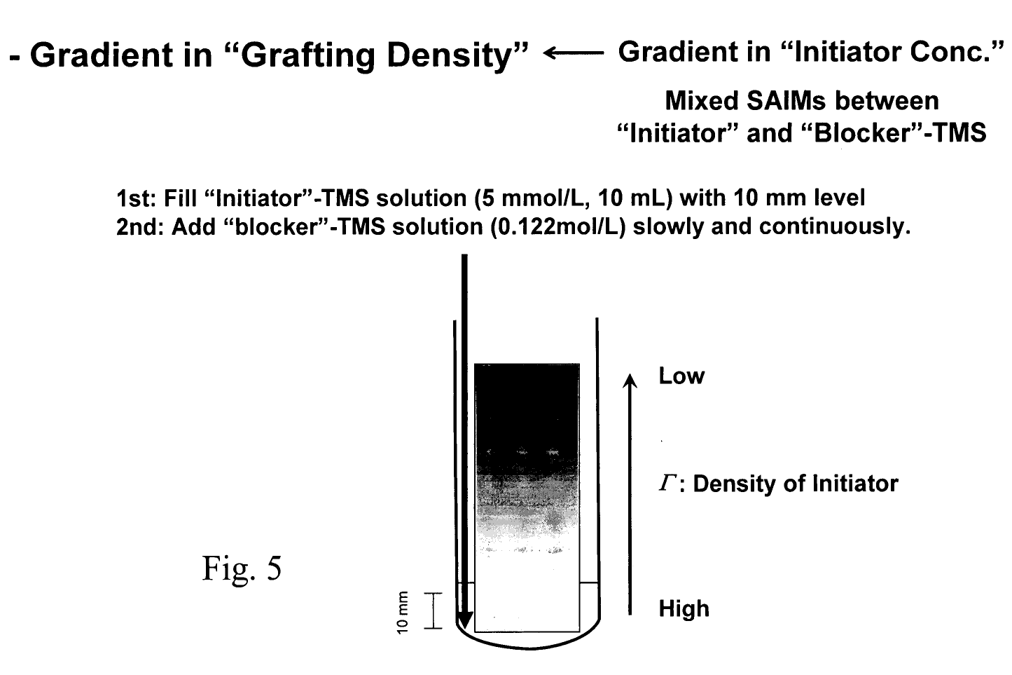

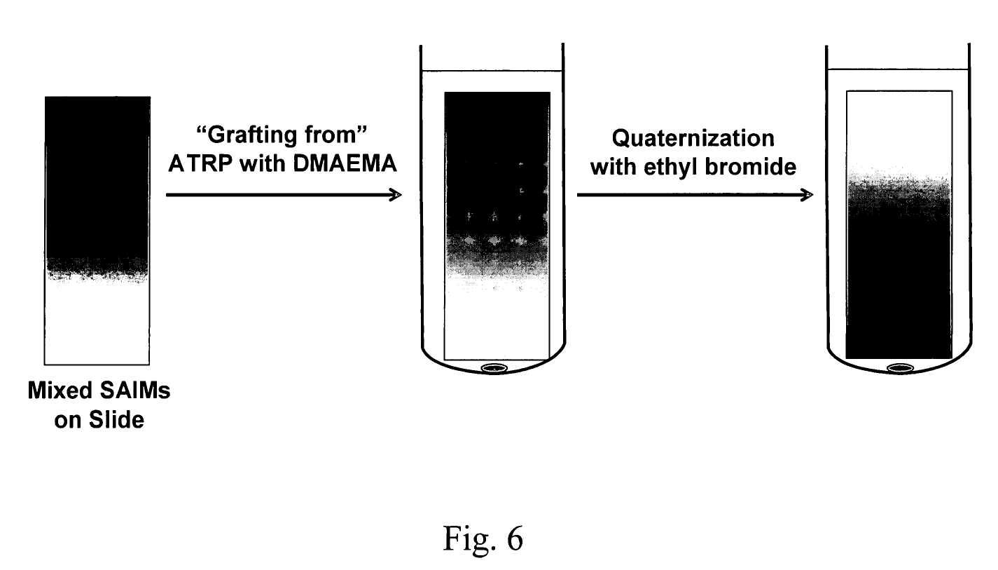

FIG. 5 illustrates the preparation of a single surface (for example, a glass slide) with a gradient in initiator concentration/grafting density over the length of the surface. In this embodiment, a reaction container in which the glass slide was placed was first filled to a height of approximately 10 mm with an initiator-TMS (see FIG. 2) solution (5 nmol/L, 10 mL). A blocker-TMS (see FIG. 2) solution (0.122 mol/L) was then added slowly and continuously, resulting in a decrease in initiator concentration in an upward direction over the length of the surface. Continuous addition of blocker-TMS results in a continuously varying gradient in initiator concentration. FIG. 6 illustrates ATRP polymerization of DMAEMA on the gradient-initiated surface and subsequent quaternization.

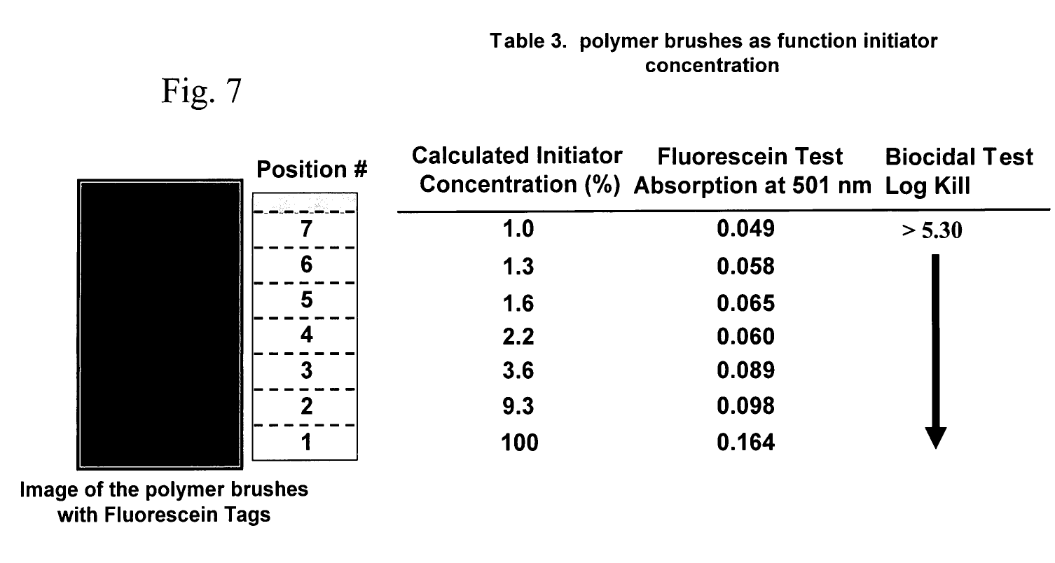

FIG. 7 illustrates an image of fluorescein tags on a surface produced in a manner similar to that set forth in FIGS. 5 and 6. In the surface of FIG. 7, however, seven different sections of initiator concentration were created by periodic addition of blocker-TMS solution. Table 3 (accompanying FIG. 7) sets forth the results of an adsorption study (501 nm) of fluorescein as a function of position/initiator concentration on the surface and the result of biological testing. The log kill in the biological testing was found to be greater than 5.30 for all calculate initiator concentrations.

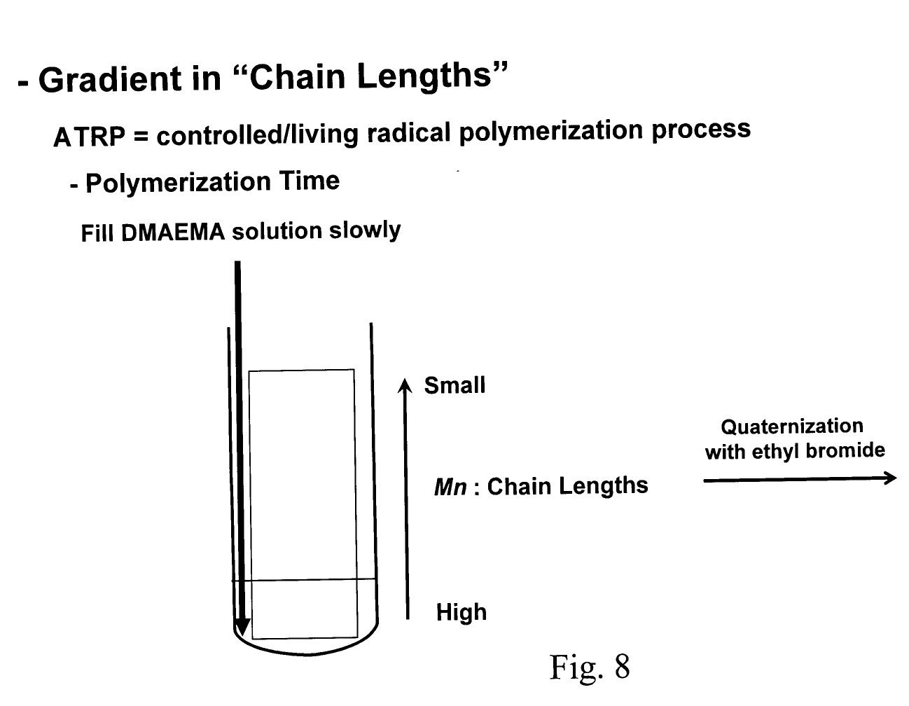

FIG. 8 illustrates the preparation of a combinatorial surface (for example, a glass slide) with a gradient in average polymer chain length over the length of the surface. In this study, a glass slide having a constant initiator concentration or density over its surface area was placed in a reaction container. DMAEMA solution then was added slowly. Because polymerization time decreased over the length of the surface as illustrated in FIG. 8, chain length decreased over the length of the surface. After the ATRP polymerization process, quaternization was carried out with ethyl bromide as described above.

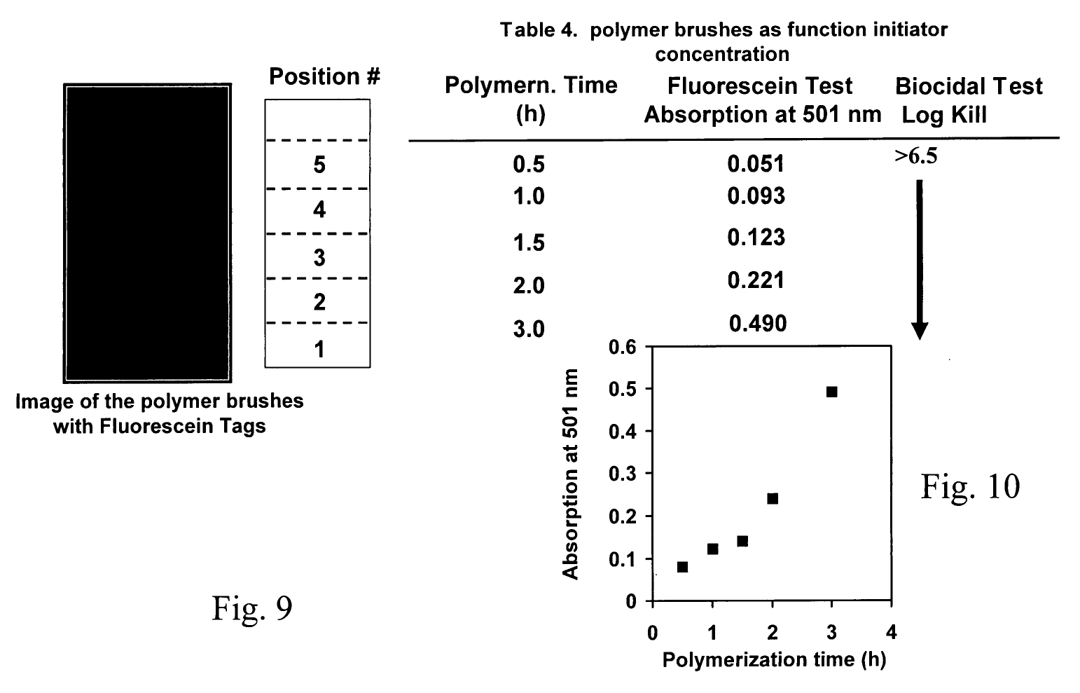

FIG. 9 illustrates an image of fluorescein tags on a surface produced in a manner similar to that set forth in FIG. 8. In the surface of FIG. 9, five different sections of different chain length were created by periodic addition of DMAEMA solution. FIG. 10 and accompanying Table 4 set forth the results of an adsorption study (501 nm) of fluorescein as a function of position/chain length on the surface and the result of biological testing. The log kill was found to be greater than 6.5 for all chain lengths tested.

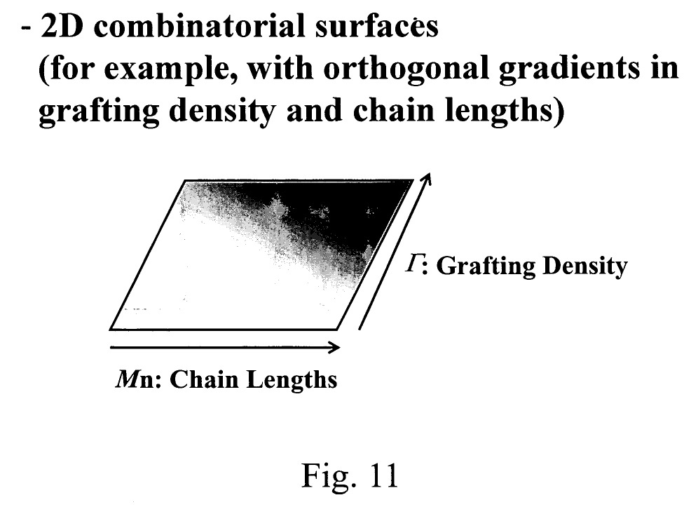

FIG. 11 illustrates a multi-dimensional (for example, a two-dimensional) combinatorial surface in which more than one physiochemical property is varied spatially over the area of the surface. For example, a gradient in initiator concentration can be created over the length of the surface as described in FIG. 5. The orientation of the surface can then be change by 90° and a generally orthogonal gradient in chain length or degree of polymerization can be created over the width of the surface as described in FIG. 8.

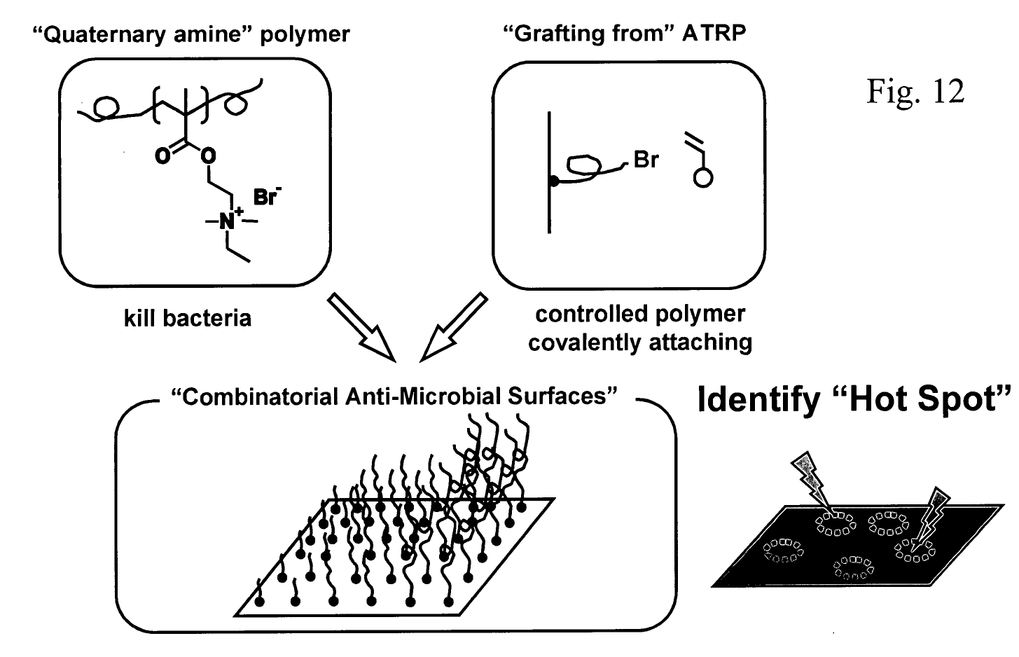

FIG. 12 illustrates an overview of a combinatorial approach for exploring “hot spots” (or spatial areas of high biocidal activity) in surfaces with multi-dimensional gradients in physiochemical properties (for example, two-dimensional gradients in grafting density and average chain length/degree of polymerization) as described above. The position of such hot spots on the surface identifies the associated physiochemical properties of the surface-attached polymers. Once such physiochemical properties are identified for a particular hot spot or spots, additional combinatorial gradient surface can be prepared to having gradients of physiochemical properties tuned to the hot spot values of such properties. In this manner, physiochemical properties can be optimized.

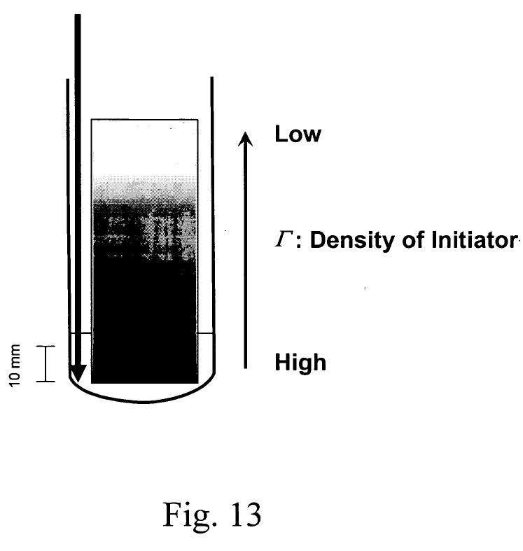

As described above, different amounts of the polyquaternary amine (PQA) can be grown from various positions on a surface such as a slide by limiting the number of active initiation sites on the surface. FIG. 13 summarizes a method for generation of a linear gradient of polyquaternary amine along the length of the slide. In these studies, initiator-TMS solution (5 mmol/L, 10 mL) was added to the 10 mm level. Subsequently, blocker-TMS solution (0.122 mol/L) was slowly and continuously added. The polymer was grown from the initiator sites, resulting in a gradient of polymer density.

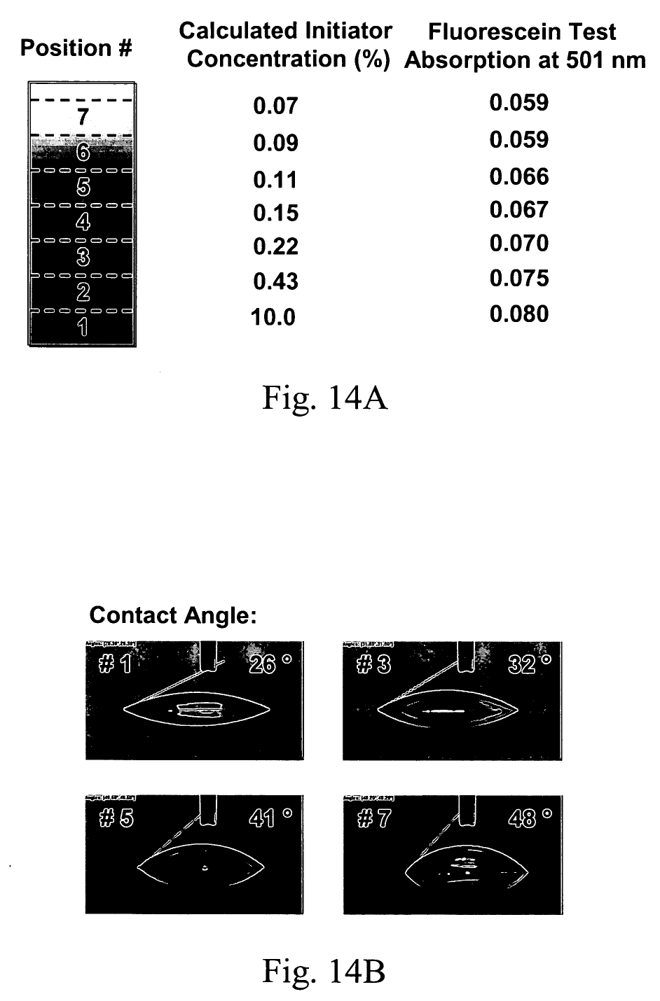

For the gradient slides, the fluorescein test estimates the density of the polymer on the surface by binding to the quaternary amines as illustrated in FIG. 14A. The fluorescein test thus provides a measurement of the density of quaternary amines or charge density. As illustrated in FIG. 14B, the contact angle or a water droplet changes across the slide because the PQA is hydrophilic and improves the wetability of the surface. Both the fluorescein and test and the contact angle test confirmed a gradient in polyquaternary amine.

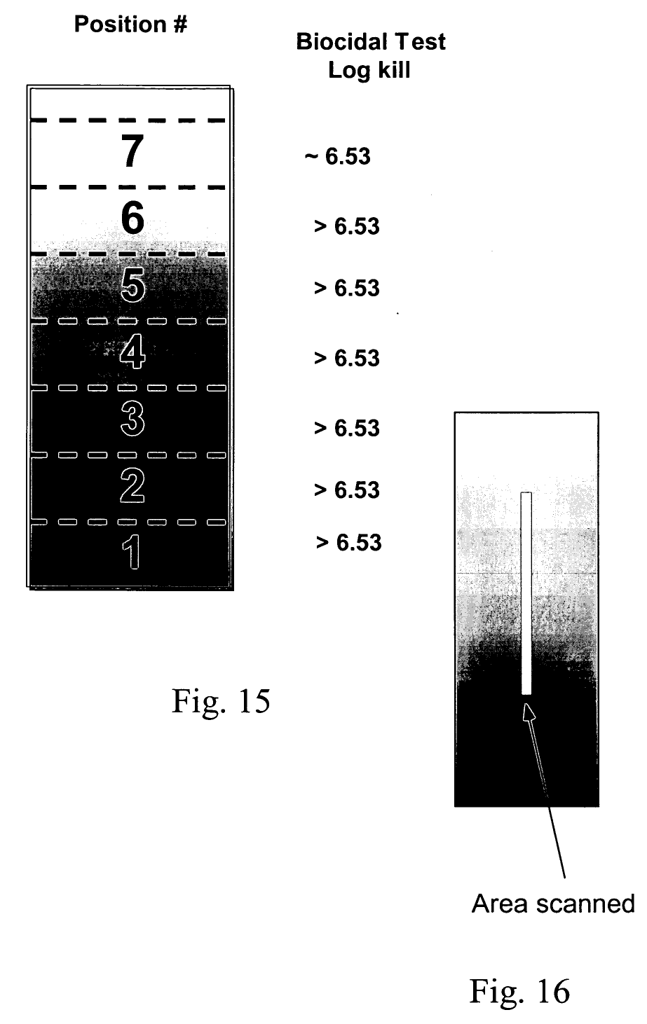

One can presume that over a certain range, the lower the amount of polyquaternary amine (or the lower the charge density)—the lower the cell kill. However, it is desirable to determine a point at which there is sufficient polyquaternary amine such that adding more does not improve efficiency. In several of the studies set forth above, the slides were cut, broken or otherwise separated into pieces or sections and each section was tested for antimicrobial activity. Such testing can be performed only on sections of sufficient size (for example, approximately 1 cm²). Such testing is likely to miss transition regions as illustrated, for example, by the data set forth in FIG. 15 in which the slide showed no appreciable difference in kill across the entire gradient. However, it was known that a gradient in polyquaternary amine was prepared on the studies slide as confirmed by contact angle and fluorescein testing.

A solution for the testing problems set forth above is to develop an assay that tests every bacterium at every position on the slide as described, for example, in connection with FIG. 12. Potential problems arise, for example, in that the size of bacteria range between approximately 1 and 10 μm, and dead cells appear the same as live cells in a light microscope. However, fluorescent probes are available (for example, from Molecular Probes/Invitrogen Corporation of Carlsbad, Calif.) that differentially stain live bacteria versus dead bacteria. In that regard, live cells stain green, while dead cells stain red. Furthermore, a laser scanning cytometer is available from Compucyte of Cambridge, Mass. under the name iCyte™ Automated Imaging Cytometer that can find a live or dead cell anywhere on a slide. See, for example, the iCyte Automated Imaging Cytometer specification sheet, the disclosure of which is incorporated herein by reference.

A test using the iCyte Automated Imaging Cytometer on a gradient slide of the present invention is described in connection with FIG. 16. In several studies, a glass slide was prepared with a gradient of polyquaternary amine as described above. Freshly grown E. coli (for example, approximately 1×10⁹) were mixed and reacted with an assay reagent (for example, the Molecular Probes live/dead assay reagent or BACLITE live/dead assay reagent, available from Invitrogen). A control glass showed all cells were alive at the start of the experiment. The solution was dropped onto the gradient slide and covered with a glass coverslip. In other experiments E coli cells were grown overnight, pelleted in a centrifuge, resuspended in buffer, and reacted with the treated surface. After a reaction period the reactive surface was rinsed and the adherent bacteria were stained. Live cells were stained green and dead cells were stained red. The slide was inserted into the slide holder of the iCyte Automated Imaging Cytometer and a scan performed.

The software available with the iCyte Automated Imaging Cytometer can quantify the number of red and green cells within a given region (not set forth for this sample). Similar software capabilities are available from public sources (for example Image J distributed as freeware by the National Institutes of Health). The scan also detects imperfections in the slide and the polymer coating that can confound analysis by assay of individual pieces of the slide.

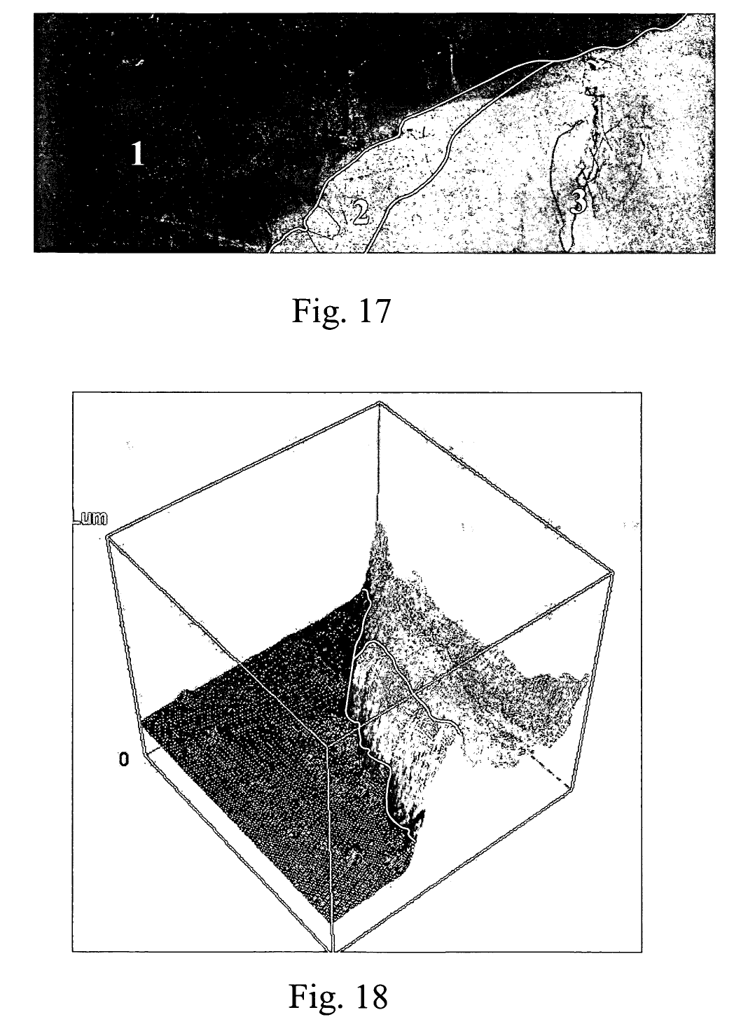

Scans of both one-dimensional and two-dimensional gradient slides (prepared as described above) were performed using the iCyte Automated Imaging Cytometer. Results from one of these scans are shown in FIGS. 17 and 18. The slide was produced as a 5-90% gradient in initiator content in one dimension and 2 to 8 hours of polymer growth (average chain length) in the other dimension. The polymer brushes were grown with DMAEMA as monomer and quaternized with bromoethane. FIG. 17 is a mosaic of the scan. The mosaic images of the scanned slide in FIG. 17 are a composite of >8000 individual, high resolution images. This scan shows clear cut-off regions between areas where bacteria fail to bind (black or area 1), areas where bacteria bind but are not killed during the 30 minute incubation (green or area 2), and areas where bacteria bind and are killed (red or area 3). As the slides are illustrated in black and white, white lines are overlayed in the areas of the transitions between areas 1, 2 and 3 in FIGS. 17 and 18.

Analysis of the data in FIGS. 17 and 18 reveals that, for polymer brushes grown from the surface of glass slides, the minimum conditions for generation of biocidal activity are 5% initiator and 6 hours polymer growth. Further, higher initiator concentrations give active surfaces with shorter periods of polymer growth (corresponding to shorter average chain length and lower DP). These observations reinforce the conclusion drawn in connection with FIGS. 14A through 15 that an important factor for surface active quaternary amine biocides is the surface concentration of available quaternary amine groups or charge density. The major contribution of a quaternary amine group to the chemistry of a surface is the positive charge on the amine nitrogen.

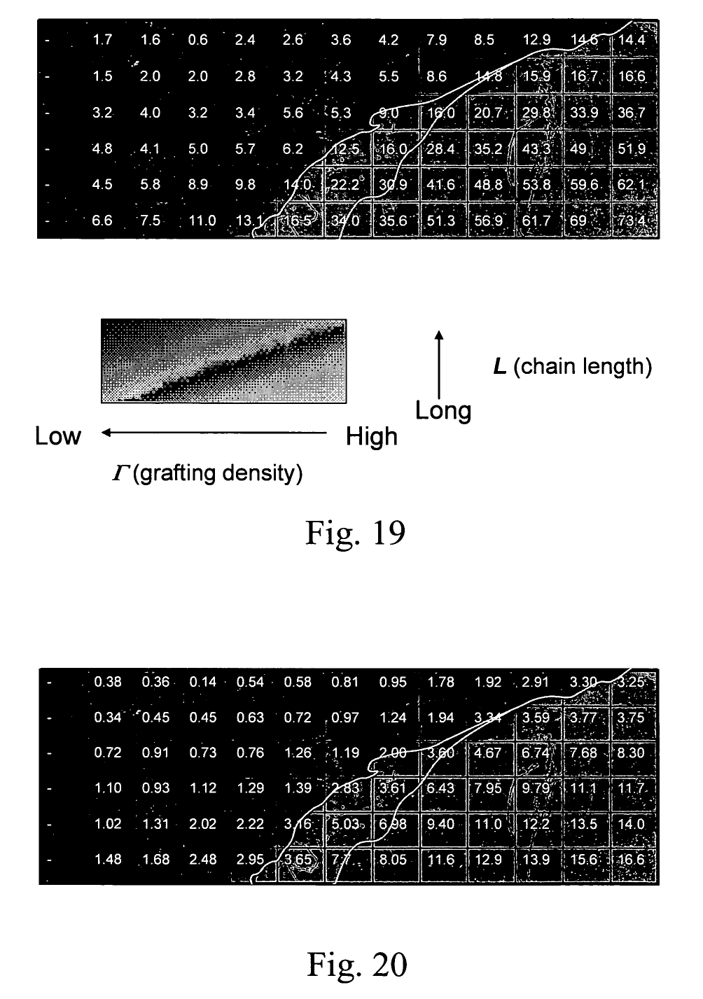

In FIGS. 19 and 20, the surface ellipsometry data and the calculated charge density from a silicone wafer that was produced at the same time and in the same reaction vessel as the slide of FIGS. 17 and 18 are superimposed on the image of that slide. To gain a better understanding of the relationship between polymer layer thickness and cell killing, the data from the ellipsometry analysis is superimposed on the image of the scanned slide (see FIG. 19). This study shows a clear correspondence between layer thickness and kill. Charge density was calculated as set forth below (assuming 100% initiation and constant chain length):

Estimation of number of quaternary ammonium unit by layer thickness (L nm):

Area of surface for each ellipsometer measurement: 3 mm² (3×10⁻² cm²)

Assumed density of polymer as 1.0 g/cm³

$$⟶ ( L \times {10}^{- 1} ) [ cm ] \times ( 3 \times {10}^{- 2} ) [ {cm}^{2} ] \times ( 1.0 ) [ g \text{/} {cm}^{3} ] = 3 L \times {10}^{- 9} [ g ]$$

$$\begin{matrix}\begin{matrix}Molecular weight of monomer unit \text{:} 266.18 g \text{/} mol \\ Abogadro number \text{:} 6.022 \times {10}^{23} / mol\end{matrix} \\ Area \text{:} 3 {mm}^{2} ( 3 \times {10}^{- 2} {cm}^{2} )\end{matrix}$$

$$\begin{matrix}⟶ Number of QA unit [ {N}^{+} \text{/} {cm}^{2} ] = \frac{3 L \times {10}^{- 9} [ g ] \times 6.022 \times {10}^{23} [ / mol ]}{266.18 [ g \text{/} mol ] \times 3 \times {10}^{- 2} [ {cm}^{2} ]} \\ = 0.226 L \times {10}^{15} [ {N}^{+} \text{/} {cm}^{2} ]\end{matrix}$$

$${Put layer thickness L [ nm ]}^{↑}$$

In general, charge density is preferably at least 1×10¹⁴, or even 5×10¹⁴, or even 1×10¹⁵, or even 5×10¹⁵, of even 1×10¹⁶.

As illustrated above, charge density can be controlled by control of grafting density and/or average chain length. In the case of a homopolymer of DMAEMA, each monomer repeat unit included one quaternary amine. Charge density can also be controlled by, for example, creating copolymer with differing repeat units, some of which include a quaternary amine of some of which do not. As clear to one skilled in the art, charge density is decreased by including repeat units which do not include a quarternary amine.

Using CRP such as ATRP one can, for example, achieve a desired degree of polymerization within a variation of no greater than 50%, or even no greater than 25%, or even no greater that 10%. Likewise, one can, for example, achieve a desired polydispersity with a variation of no greater than 50%, or even no greater than 25%, or even no greater that 10%. In general, control of polydispersity becomes less accurate as average polymer chain length is increased. Further, using the methods described above, one can achieve a desired grafting density within a variation of no greater 20%, no greater than 10%, no greater than 5%, and even no greater than 2%. In controlling grafting density, it may (as clear to those skilled in the art) be necessary to take into account different reaction rates of initiator and blocking agent as well as differences in reactive functionality (or number of functional groups available to react with reactive surface groups).

Using the combinatorial techniques of the present invention, a BSAs can readily be optimized for a particular surface and for one or more particular microbial agents. For example, in the case of a very smooth surface, it may be desirable to use polymers having relatively short average chain length (having few quarternary amine or other cationic groups per chain) with a relatively high grafting density. In the case of a surface with a relatively rough or varying microstructure, use of polymers with longer average chain length may be desirable.

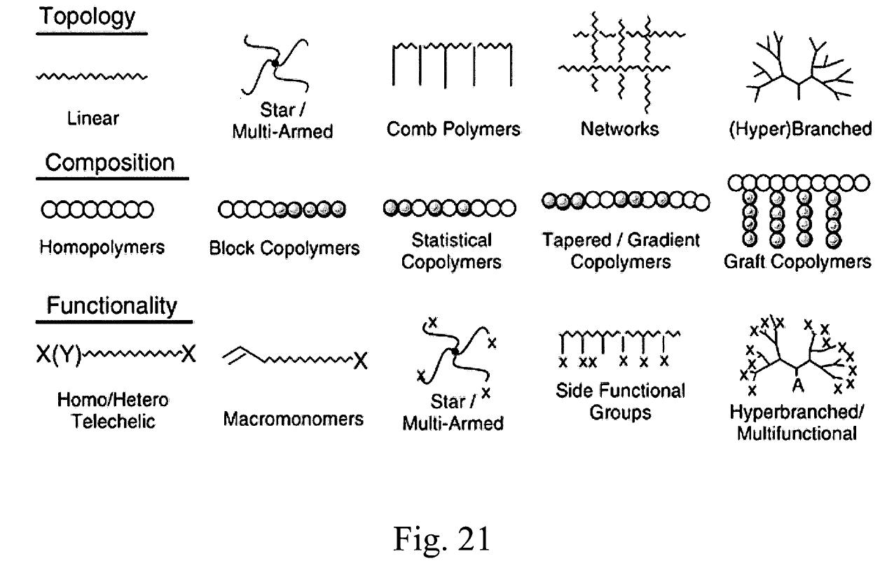

In addition to varying the nature of the BSA itself, the way in which BSA's are presented to invading organisms and the chemical properties of the surface created through ATRP can affect the efficiency of organism destruction. The versatility of ATRP allows for the creation of a wide range of macromolecular compositions and architectures/topologies. FIG. 21 illustrates several different polymer architectures/topologies that can be produced in the present invention via, for example, ATRP.

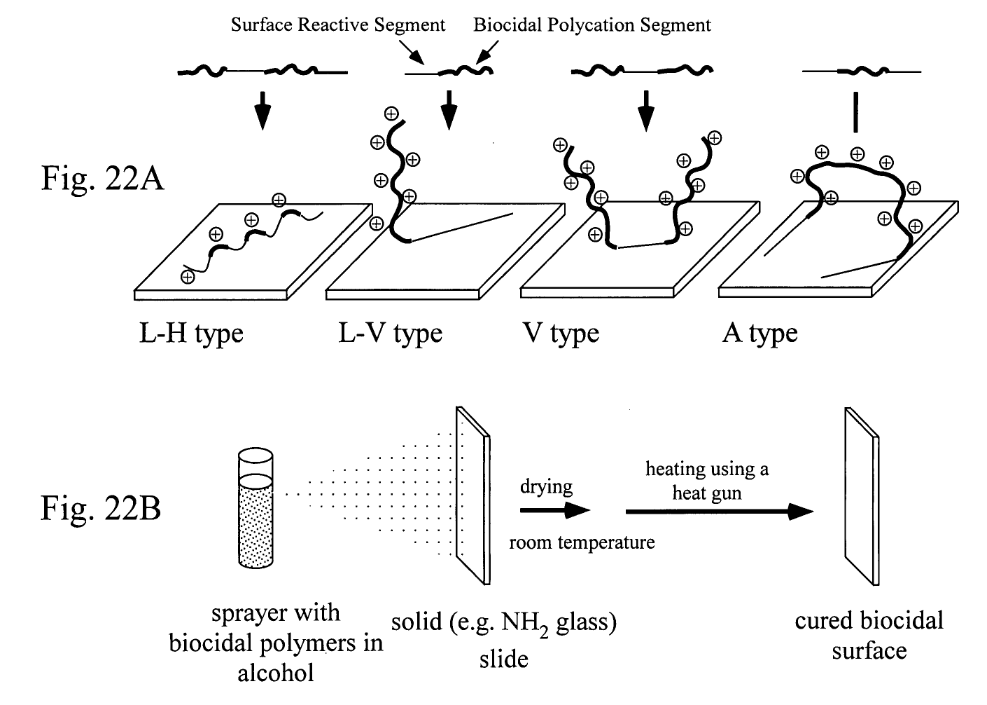

Another physiochemical property that can be studied using a CRP such as ATRP is the manner in which each molecule is coupled to the material, that is by single or multiple sites (see, for example, FIG. 22A). The bioactivity of the same polymer which is coupled to the surface in different ways is likely to differ greatly. Each of the types of “BSA presentation” set forth in FIG. 22A can be readily generated through, for example, ATRP. For example, the “L-V” type is generated through the sequential addition of two monomers, one that interacts favorably with the surface, followed by the BSA-containing monomer. The A type is generated in the same way, albeit with two sequences of surface loving monomer. The other BSA presentations can be created using similar strategies.

The choice of co-monomer(s) and surface(s) likewise plays a significant role in determining the way in which the BSA is presented to invading organisms. Once again, high throughput screening assessment tools of the present invention can be used to examine numerous combinatorial options. For example, one can employ a model hydrophobic co-monomer (such as a fluoroacrylate) and a model hydrophilic co-monomer (such as hydroxyethyl methacrylate) in combination with various surfaces.

In addition to using ATRP to grow polymers from a surface, ATRP can also be use in solution to grow surface reactive polymers. In that regard, one can, for example, synthesize random, diblock, and triblock copolymers containing biocidal/sporicidal segments and surface-reactive segments (SRS). In a representative example the biocidal is composed of a quaternized N-substituted (meth)acrylate, which cause cell/spore death and the SRS is a polymer of (meth)acrylate monomer with alkyl halide or isocyanate as pendant groups and will react with OH or NH₂ groups on surfaces by alkylation or forming urethane bond. This embodiment has several advantages regarding the surface immobilization of biocidal polymers. For example, changing polymer types such as, random, diblock, and triblock copolymers allows manipulation of antibacterial polycations in four different ways: (1) linear-horizontal (L-H), (2) linear-vertical (L-V), (3) anchor (A), and (4) V shapes (see FIG. 22A) to investigate bactericidal action and its kill mechanism. Also control of molecular weights to, for example, provide narrow molecular weight distribution can improve antibacterial property, and the reduced radical coupling of adjacent growing chains from living polymerization can provide large number of linear flexible polymers to contact cell surface. Moreover, an SRS polymer chain has many surface-reactive side groups, which makes the biocidal polymer strong because multi-point covalent attachments throughout one polymer chain are possible. Further, an antimicrobial solution can, for example, be sprayed or otherwise applied onto surface like conventional antibacterial materials (see FIG. 22b). The biocidal solution can, for example, react with OH or NH₂ groups on surfaces upon heating. Such an application technique allows application of a surface biocidal to a large surface or a three-dimensional, complex surface. Such surfaces are difficult or impossible to be modified using classical polymer chemistry.

Using the combinatorial approaches and statistically designed experiments of the present invention, one can assess the impact of numerous physiochemical variables or properties. In that regard, upon completion of the ATRP or other CRP reactions, one can, for example, expose BSAs to numerous recycle challenges and then challenge the plates with, for example, spectroscopically labeled liposomes, fluorescent protein containing cells (such as green fluorescent protein- or GFP-containing E. coli) and spectroscopically labeled and native spores. Performing parallel/simultaneous and/or gradient ATRP processes on one or more surfaces allows screening of thousands or even millions of target BSAs per week. Screening tests for biologically active surfaces are described, for example, in Lee, S. B., Koepsel, R. R., Morley, S. W., Matyjaszewski, K., Sun, Y. and Russell, A. (2004), Biomacromolecules, 5, 877-882, the disclosure of which is incorporated herein by reference.

In addition to killing and destroying the cell debris, it is also desirable for a surface to have an architecture or other physiochemical property(ies) that enable self-cleaning when exposed to, for example, normal weather cycles. One can, for example, mimic the function of a Lotus leaf, which is known to repel dirt as a function of nanoscale variations in hydrophobicity. In that regard, research into this phenomenon has revealed that the super-hydrophobicity of the Lotus leaf derives from the arrangement of wax particles on the surface. These particles are spaced such that water droplets, when impinging upon the surface, actually sit upon a cushion of trapped air, rather than the surface itself. The droplets exhibit a contact angle greater than 150° and a roll off angle less than 5°. The “Lotus effect” can be synthetically duplicated when micron-size (or smaller) particles are deposited on a surface. As with the wax particles on a Lotus leaf, water droplets, rather than sitting on the surface itself, sit on a cushion of air between the particles.

One can, for example, combine the self-cleaning properties of the Lotus leaf with the killing power of the novel BSAs of the present invention through the creation of “hairy” particles (that is, particles from which BSA-containing polymers have been grown). Such “hairy” particles can, for example, be created using ATRP. The size of the particles, and their distribution on a polymer surface, can create the traditional Lotus effects of high contact angle and low roll-off angle. Further, the presence of surface biocidals or antimicrobials on the particles can eliminate organisms upon contact.

To create such “hairy” particles, one can first functionalize silica (of defined size) with an initiating species. For the case of an ATRP-derived polymer, one can react silica (via surface Si—OH groups) with a bromoalkyl trialkoxysilane (available, for example, from Gelest, Inc). As described above, the bromoalkyl species becomes the point of initiation of the polymer when monomer and catalyst are added. To test the efficacy of our BSA-modified Lotus effect, one can employ methods from the literature to create hairy-particle surface. The particles can be slurried with a base material in a solvent, deposited onto a substrate, and the solvent removed under vacuum. The literature has shown that the size of the particles is important to creating the Lotus effect, rather than a specific arrangement of the particles on the surface.

### Experimental

Preparation of Poly(DMAEMA) Brushes on the Substrates. The first step in the preparation of polymer brushes via “grafting from” ATRP polymerization is the self-assembly of the initiator species on the surface of the substrates. In this study, we have used bromine-initiators that carry trialkoxysilane end-group that can both potentially react with silanol groups on SiOₓ surfaces and bromine group on other side that can behave as an initiator in the presence of Cu cation and ligand.

The polymeric quaternary ammonium brushes are synthesized by preparing polymer brushes of 2-(dimethylamino)ethyl methacrylate (DMAEMA) using the “grafting from” ATRP technique where the polymers are grown directly from a surface, as shown in FIG. 2. After polymerization the poly(DMAEMA) brushes were rinsed and extensively extracted with acetone. The advantage of “grafting from” ATRP for preparing such surfaces is that a variety of radical polymerizable monomers can be chosen and the molecular distribution of the obtained polymer may be relatively narrow. Contact angle of deionized water of poly(DMAEMA) brush shows around 65°.

Quaternization of the Poly(DMAEMA) Brushes with n-Alkyl Bromide. The poly(DMAEMA) brushes are promising candidates as general starting material for many different quaternary ammonium polymer brushes, since the quaternization of amino group with alkyl bromides is well-studied. The quaternary ammonium polymer brushes as biocidal materials used in this study were obtained by quaternization of poly(DMAEMA) using alkyl bromides in acetonitrile or acetonitrile/chloroform mixture solution. After quaternization with bromoethane, the number of quaternary ammonium units in polymer brushes was estimated by fluorescein dye staining. Fluorescein binds to quaternary amines and gives the stained surface a reddish brown color. The bound fluorescein can be removed from the surface with detergent and the amount determined with a spectrophotometer. The investigation of hydrophilicity of the obtained polymer brushes were carried out by measuring contact angle of water. After quaternization of the polymer brush with ethyl bromide, the contact angle of deionized water was significantly changed to around 20° from 65° before quaternization.

Immobilization of Initiator-TMS on SiOₓ substrates. Substrates were placed in a test tube and covered with toluene (50 mL), triethylamine (500 μL) and 82 mg of (3-(2-bromoisobutyryl)propyl)trimethoxysilane or N-(3-trimethoxysilylpropyl)-2-bromoisobutylamide (initiator-TMSs) were added and kept at 80° C. for 1 h. The modified substrates were then rinsed with toluene, methanol and acetone.

“Grafting From” ATRP. Initiator modified substrates were placed in a polymerization tube and covered with DMAEMA, ligand and 1,2-dichlorobenzene in the desired ratio. The polymerization solutions were degassed by five freeze-pump-thaw cycles and then polymerization catalyst Cu(I)Br was added under nitrogen flowing. The polymerization solutions were heated to 40° C. overnight. The substrates were then extracted in Acetone for at least 6 h to remove free polymer from the polymeric layer. The samples were dried in vacuo.

Quaternization of Poly(DMAEMA) Brush with n-Alkyl Bromide. To the substrates with poly(DMAEMA) brush in acetoinitrile or acetonitrile and chloroform mixture solution (100 mL), the desired n-alkyl bromide (10 mL) was added and the reactor was kept at 40 or 55° C. for 16 h. The substrates were then rinsed in THF, methanol and acetone and then dried in vacuo.

Although the present invention has been described in detail in connection with the above embodiments and/or examples, it should be understood that such detail is illustrative and not restrictive, and that those skilled in the art can make variations without departing from the invention. The scope of the invention is indicated by the following claims rather than by the foregoing description. All changes and variations that come within the meaning and range of equivalency of the claims are to be embraced within their scope.

What is claimed is:

1. A biocidal article, comprising:
a surface comprising a plurality of polymers covalently attached to the surface, the polymers comprising biocidal cationic groups, the polymers having a molecular weight distribution less than 3, a grafting density of the polymers on the surface being controlled, an average degree of polymerization of the polymers being controlled and repeat units of the polymers being chosen to provide a predetermined charge density arising from the cationic groups.

2. The biocidal article of claim 1, wherein the molecular weight distribution is less than 2.5.

3. The biocidal article of claim 2, wherein the molecular weight distribution is less than 2.0.

4. The biocidal article of claim 1 wherein the predetermined charge density is determined specifically for the surface.

5. The biocidal article of claim 1 wherein the predetermined charge density is determined for at least one specific bacterial agent.

6. The biocidal article of claim 1 wherein the polymers are grown via controlled radical polymerization.

7. The biocidal article of claim 6 wherein the polymers are grown via atom transfer radical polymerization.

8. The biocidal article of claim 7 wherein the polymers are grown in solution and subsequently attached to the surface.

9. The biocidal article of claim 7 wherein a plurality of initiators are attached to the surface and the polymers are grown from the initiators.

10. The biocidal article of claim 1, wherein the biocidally active groups comprise at least one of a quaternary ammonium salt and a quaternary phosphonium salt.

11. The biocidal article of claim 7, wherein the biocidally active groups comprise at least one of a quaternary ammonium salt and a quaternary phosphonium salt.

12. The biocidal article of claim 1, wherein the grafting density is controlled by reaction of blocking compounds with active groups on the surface.

13. The biocidal article of claim 1, wherein the plurality of polymers are one of homopolymers and copolymers.

14. The biocidal article of claim 1, wherein the plurality of polymers comprise at least one of a block copolymer, multiblock copolymer, a random copolymer, graft polymer, a branched or a hyperbranched polymer, and a gradient copolymer.

15. The biocidal article of claim 1, wherein the plurality of polymers have an average degree of polymerization between 4 and 10000.

16. The biocidal article of claim 15, wherein the plurality of polymers have an average degree of polymerization between 4 and 1000.

17. The biocidal article of claim 16, wherein the plurality of polymers have an average degree of polymerization between 4 and 100.

18. The biocidal article of claim 1, wherein at least one monomer for growing the polymers is derived from at least one of 2-(dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers.

19. The biocidal article of claim 1, wherein the surface is at least one of silicon, gold, silica functionality, a cellulosic materials, a surfaces with one of amino and hydroxy functionality, plain glass, amino glass, polymeric material, a polymeric coating, polyethylene, polypropylene, polystyrene, aluminum, steel, paper, wood, porcelain, wool, cotton, porous glass beads and ion exchanger resin.

20. The biocidal article of claim 1, further comprising a linking group between the surface and the polymer.

21. The biocidal article of claim 20, wherein the linking group is of the formula: 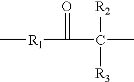
where R₁ is one of O, an ester, amide, aliphatic hydrocarbon, aromatic hydrocarbon or NH, R₂ and R₃ are, independently, one of H, CH₃, OOCC₂H₅ or CN.

22. The biocidal article of claim 1, wherein a monomeric unit of at least a portion of the plurality of polymers comprises the biocidally active group.

23. The biocidal article of claim 22, wherein the monomeric unit is at least one monomeric unit selected from the following formulae: 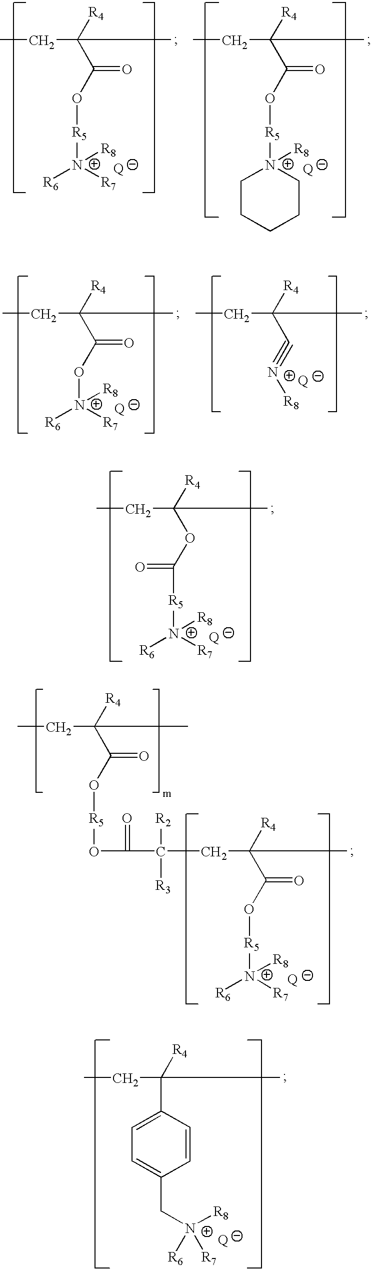 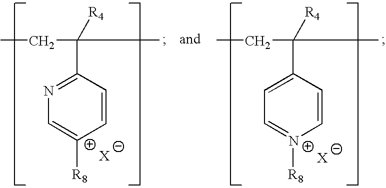
where R₄ is one of H, CH₃, Cl or CN, R₅ is —(CH₂)ₙ— and —CH₂C(CH₃)₂CH₂—, n is from 1 to 6, R₆ and R7 are, independently, one of C₁-C₅ alkyl or isopropyl, R₈ is H, C₁-C₁₆ alkyl and benzyl and Q is one of F, Cl, Br, I, CF₃SO₃ and CF₃CO₂, individually or in any combination each, X is a radically transferable atom or group or a group derived from the radically transferable atom or group, such as an additional polymer block, a hydroxy group, H, branched or straight chain alkyl or cyclic, and Q is one of F, Cl, Br, I, CF₃SO₃ and CF₃CO₂.

24. A process for preparing a biocidal article, comprising:
controlling a grafting density of polymers that are covalently attached to a surface, the polymers comprising biocidal cationic groups,
controlling a chain length of the polymers, and
choosing repeat units of the polymers;
such that a predetermined charge density arising from the cationic groups is achieved.

25. The process of claim 24 wherein at least one of grafting density, chain length, repeat units and charge density is determined by attaching a plurality the polymers to one or more of the surfaces so that at least one of grafting density, chain length or repeat units is varied; and exposing the polymer to at least one agent.

26. The process of claim 24 wherein at least one of grafting density, chain length, repeat units and charge density is determined by attaching a plurality of the polymers to the surface so that at least one grafting density, chain length or repeat units is varied to create a gradient in at least a first direction on the surface; and exposing the polymer to at least one agent.

27. The process of claim 24 wherein the polymers are grown via controlled radical polymerization.

28. The process of claim 24 wherein the polymers are grown via atom transfer radical polymerization.

29. The process of claim 29 wherein the polymers are grown in solution and subsequently attached to the surface.

30. The process of claim 29 wherein a plurality of initiators are attached to the surface and the polymers are grown from the initiators.

31. The process of claim of claim 24, wherein the biocidal cationic groups comprise at least one of a quaternary ammonium salt and a quaternary phosphonium salt.

32. The process of claim 29, wherein the biocidal cationic groups comprise at least one of a quaternary ammonium salt and a quaternary phosphonium salt.

33. The process of claim 28, wherein polymerizing occurs in the presence of a system initially comprising a transition metal complex and initiator attached to the surface comprises a radically transferable atom or group.

34. The process of claim 33, wherein the radically transferable atom or group is one of a chlorine, iodine, and bromine.

35. The process of claim 33, wherein the monomers comprise at least one 2-(dimethylamino)ethyl methacrylate), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, or derivatives or substituted varieties of such monomers.

36. The process of claim 24, wherein cationic groups are added to the polymers by converting a group thereof to a quaternary salt by reacting the group with an alkyl halide.

37. The process of claim 36, wherein the alkyl halide is one of C₁-C₁₂ alkyl halide.

38. The process of claim 36, wherein the halide of the alkyl halide is one of chlorine and bromine.

39. The process of claim 24, further comprising reacting a compound comprising an initiation group with a functional group on the surface to form an initiator attached to the surface.

40. The process of claim 39, wherein the functional group on the surface is at least one of —OH and —NH₂.

41. The process of claim 39, further comprising reacting a blocking agent without initiation functionality on the functional group on the surface of the article.

42. A method of analyzing biocidal activity of biocidal surface agents, comprising the steps:
attaching a plurality of chemical entities to one or more surfaces so that at least one physiochemical property is varied, each of the chemical entities comprising at least one biocidally active component; and
exposing the chemical entities to at least one biological agent to determine the effect of the at least one physiochemical property upon biocidal activity.

43. The method of claim 42 wherein the at least one physiochemical property is varied in a systematic manner.

44. The method of claim 44 wherein the at least one physiochemical property is a physiochemical property of the surface to which the chemical entities are attached.

45. The method of claim 42 wherein the at least one physiochemical property is a physiochemical property of the chemical entities.

46. The method of claim 43 wherein the chemical entities are chemically bonded to the one or more surfaces.

47. The method of claim 46 wherein the chemical entities are polymers.

48. The method of claim 47 wherein the polymers are polymerized in a controlled radical polymerization process.

49. The method of claim 47 wherein the polymers are polymerized and subsequently attached to the surface via at least one surface reactive group of the polymers.

50. The method of claim 49 wherein the polymerization is atom transfer radical polymerization.

51. The method of claim 48 wherein the polymers are bonded to the one or more surfaces by polymerizing radically polymerizable monomers from an initiator attached to the one or more surfaces.

52. The method of claim 51 wherein the polymerization process is atom transfer radical polymerization.

53. The method of claim 52 wherein the polymers are attached to a single surface and the at least one physiochemical property is a varied to create a gradient in the at least one physiochemical property in a first direction on the surface.

54. The method of claim 53 wherein at least a second physiochemical property is varied to create a gradient in the second physiochemical property in a second direction on the surface.

55. The method of claim 54 wherein the first direction and the second direction are generally orthogonal.

56. The method of claim 47 wherein the physiochemical property is one of molecular weight, polydispersity, degree of surface reactivity, local homogeneity of the biocidally active component, macro homogeneity of the biocidally active component; surface density of the polymeric chemical entities, architecture of the polymeric chemical entities, number of points of attachment to the surface of the polymeric chemical entities, chemical composition of the polymeric chemical entities or surface topology.

57. The method of claim 47 wherein the polymeric chemical entities are homopolymers or copolymers.

58. The method of claim 47 wherein the polymeric chemical entities are block copolymers, random copolymers or graft copolymers.

59. The method of claim 47 wherein the polymeric chemical entities are dendritic polymers, comb polymers, linear polymers, branched polymers, networked polymers, or star polymers.

60. The method of claim 42 wherein the one or more surfaces comprise at least one of silicon, gold, a cellulosic material, glass, a polymeric material, aluminum, steel, porcelain, wool, cotton or an ion exchanger resin.

61. The method of claim 60 wherein the one or more surfaces comprise a plain glass, an amino glass or a porous glass bead.

62. The method of claim 60 wherein the cellulosic material is paper or wood.

63. The method of claim 60 wherein the one or more surfaces comprise at least one of silica functionality, amino functionality or hydroxy functionality.

64. The method of claim 60 wherein the one or more surfaces comprise a polymeric coating.

65. The method of claim 60 wherein the polymeric material is polyethylene, polypropylene or polystyrene.

66. The method of claim 42 wherein a combinatorial library of surfaces are formed.

67. The method of claim 66 wherein a plurality of surfaces are formed wherein a first physiochemical property is maintained generally constant on all the surfaces and a second physiochemical property is varied in a systematic manner among the surfaces.

68. The method of claim 66 wherein a plurality of physiochemical properties are varied in a systematic manner in the combinatorial library of surfaces.

69. The method of claim 42 wherein the biocidal activity is antibacterial activity.

70. The method of claim 42 wherein the biocidal activity is sporicidal activity.

71. A method of analyzing biological activity of biologically active surface agents, comprising the steps:
attaching a plurality of chemical entities to one or more surfaces so that at least one physiochemical property is varied, each of the chemical entities comprising at least one biologically active component; and
exposing the chemical entities to at least one agent to determine the effect of the physiochemical property on biological activity.

72. A method of preparing a surface for testing of biological activity, comprising the step:
attaching a plurality of chemical entities to the surface so that at least one physiochemical property of the chemical entities is varied to create a gradient in the at lease one physiochemical property in a first direction on the surface, each of the chemical entities comprising at least one biologically active segment.

73. The method of claim 72 wherein the biological activity is biocidal activity.

74. The method of claim 73 wherein the biological activity is antibacterial activity.

75. The method of claim 73 wherein the biological activity is sporicidal activity.

76. The method of claim 72 wherein the chemical entities are chemically bonded to the surface.

77. The method of claim 76 wherein the chemical entities are polymers.

78. The method of claim 77 wherein the polymers are polymerized is a controlled radical polymerization process.

79. The method of claim 78 wherein the polymers are polymerized and subsequently attached to the surface via at least one surface reactive group of the polymers.

80. The method of claim 79 wherein the polymerization is atom transfer radical polymerization.

81. The method of claim 78 wherein the polymers are bonded to the one or more surfaces by polymerizing radically polymerizable monomers from an initiator attached to the one or more surfaces.

82. The method of claim 81 wherein the polymerization process is atom transfer radical polymerization.

83. The method of claim 82 wherein at least a second physiochemical property is varied to create a gradient in the second physiochemical property in a second direction on the surface.

84. The method of claim 83 wherein the first direction and the second direction are generally orthogonal.

85. The method of claim 77 wherein the physiochemical property is one of molecular weight, polydispersity, degree of surface reactivity, local homogeneity of the biocidally active component, macro homogeneity of the biocidally active component; surface density of the polymeric chemical entities, architecture of the polymeric chemical entities, points of attachment to the surface of the polymeric chemical entities, chemical composition of the polymeric chemical entities or surface topology.

86. The method of claim 77 wherein the polymeric chemical entities are homopolymers or copolymers.

87. The method of claim 77 wherein the polymeric chemical entities are block copolymers, random copolymers or graft copolymers.

88. The method of claim 77 wherein the polymeric chemical entities are dendritic polymers, comb polymers, linear polymers, branched polymers, or star polymers.

89. A method of preparing a surface for testing of biological activity, comprising the step:
attaching a plurality of chemical entities to the surface so that at least one physiochemical property of the chemical entities is varied over an area of the surface in a known manner, each of the chemical entities comprising at least one biologically active segment.

90. The method of claim 89 wherein at least a second physiochemical property is varied over the area of the surface in a known manner.

91. The method of claim 89 further comprising the step of analyzing the effect of the at least one physiochemical property upon the biological agent.

92. The method of claim 91 further comprising the step of adding a marking agent adapted to provide an indication of the viability of the biological agent.

93. The method of claim 92 wherein the biological agent is a bacteria and the marking agent provides an indication of whether the bacteria is dead or alive.

94. The method of claim 91 wherein the chemical entities are polymers comprising cationic groups, the first physiochemical property is grafting density and the second physiochemical property is degree of polymerization.

95. The method of claim 94 wherein the polymers comprise quarternary ammonium groups or quarternary phosphonium groups.

96. A biocidal article, comprising:
a surface comprising a plurality of polymers covalently attached to the surface, the polymers comprising cationic groups selected from the groups consisting of quarternary ammonium groups and quarternary phosphonium groups, the polymers having a charge density arising from the cationic groups determined for the surface.
